(19) United States
(12) Patent Application Publication
(10) Pub. No.: US 2019/0270934 A1
(43) Pub. Date: Sep. 5, 2019

(54) LIQUID CRYSTAL COMPOSITION AND DISPLAY DEVICE THEREOF

(71) Applicant: JIANGSU HECHENG DISPLAY TECHNOLOGY CO., LTD., Yangzhong, Jiangsu (CN)

(72) Inventors: Heming ZHANG, Yangzhong (CN); Wenquan DING, Yangzhong (CN); Pengfei LI, Yangzhong (CN); Wenming HAN, Yangzhong (CN); Haibin XU, Yangzhong (CN); Di HE, Yangzhong (CN)

(73) Assignee: Jiangsu Hecheng Display Technology Co., Ltd., Yangzhong, Jiangsu (CN)

(21) Appl. No.: 16/320,559

(22) PCT Filed: Jul. 19, 2017
(86) PCT No.: PCT/CN2017/093443

§ 371 Date: Jan. 25, 2019

(30) Foreign Application Priority Data
Jul. 27, 2016 (CN) 201610603058.4

(51) Int. Cl. C09K 19/30

(52) U.S. Cl. CPC C09K 19/3066; C09K 19/3003; C09K 2019/3004; C09K 2019/3025; C09K 2019/301; C09K 2019/3016; C09K 2019/3009

(57) ABSTRACT

A liquid crystal composition having a negative dielectric anisotropy and a liquid crystal display device comprising the same. The liquid crystal composition comprises: a first component comprising one or more compounds of formula I; a second component comprising two or more than two compounds of formula II; and a third component comprising one or more compounds of formula III.

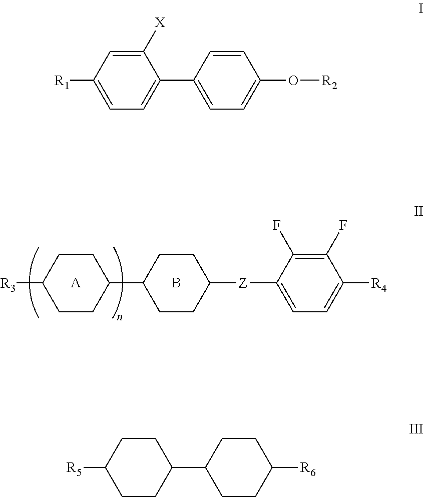

### TECHNICAL FIELD

The present invention relates to a liquid crystal composition, in particular to a liquid crystal composition having characteristics such as wider temperature range of a nematic phase, higher optical anisotropy, suitable dielectric anisotropy, good low-temperature stability, higher voltage holding ratio, good high-temperature stability and good UV resistance, and a liquid crystal display device comprising the liquid crystal composition.

### BACKGROUND ARTS

The liquid crystal display elements have been developed from clocks and calculators to various electrical apparatuses for domestic use, measuring apparatuses, automotive panels, word processors, electronic notebooks, printers, computers, televisions, etc. The representative liquid crystal display modes include TN (twisted nematic) mode, STN (supertwisted nematic) mode, DS (dynamic light scattering) mode, GH (guest-host) mode, IPS (in-plane switching) mode, OCB (optical compensated birefringence) mode, ECB (electrically controlled birefringence) mode, VA (vertical alignment) mode, CSH (color super homeotropic) mode, or FLC (ferromagnetic liquid crystal) mode, etc. Furthermore, examples of the driving mode of a liquid crystal device include static driving, multiplex driving, a simple matrix method, and an active matrix (AM) method driven by TFT (thin-film transistor), TFD (thin-film diode), and the like.

Among these display modes, the IPS mode, the ECB mode, the VA mode, or the CSH mode has a characteristic of using a liquid crystal composition exhibiting a negative value of dielectric anisotropy Δε. Among these display modes, the VA display mode which is driven by AM in particular, is used for display elements applications, for example, a television and the like, which require high speed response and wide viewing angle.

For most liquid crystal displays, the liquid crystal media in the prior art have relatively unfavorable optical anisotropy (Δn) values which are often significantly less than 0.11, and in some cases less than 0.10. However, such a small Δn value is not particularly advantageous, for example, VA type displays require the use of a liquid crystal cell having a relatively large layer thickness (d) of 4 μm or more, resulting in an unacceptably long response time for many applications. Therefore, about 0.30 μm of d·Δn is employed in the case of untwisted misalignment. However, the use of a liquid crystal cell having a very small layer thickness (d) usually results in a low yield of the display. Therefore, the use of liquid crystal medium having a higher Δn value is beneficial for the display mode and the manufacture of display.

A liquid crystal composition comprising liquid crystal compounds II-1-3 and II-3-5 below having a 2,3-difluorophenylene skeleton is disclosed in JPH08104869A as a liquid crystal composition having a negative Δε.

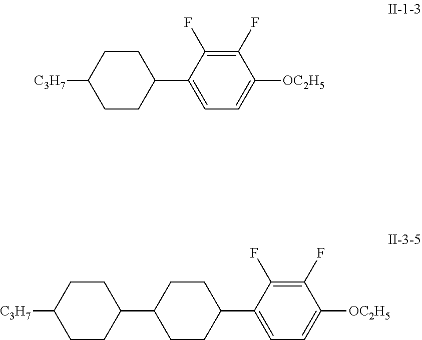

The liquid crystal composition also uses liquid crystal compounds III-2 and (A) as constituents having a Δε of substantially zero. However, in the case of a liquid crystal display requiring a high-speed response, such as liquid crystal television, the composition does not yet achieve a sufficiently low viscosity capable of satisfying the high-speed response.

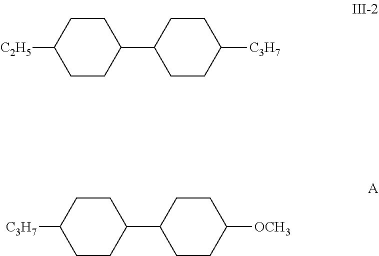

On the other hand, liquid crystal compositions using the liquid crystal compound II-6-5 have also been disclosed in EP0474062A1, which is one comprising the above liquid crystal compound (A) and having a low Δn. Since this liquid crystal composition is also one comprising compounds that have an alkenyl group within the molecules thereof (alkenyl compounds), such as the following liquid crystal compound III-10 (see JP2006037054A), it is necessary to carry out further researches to achieve both a high Δn and a high reliability.

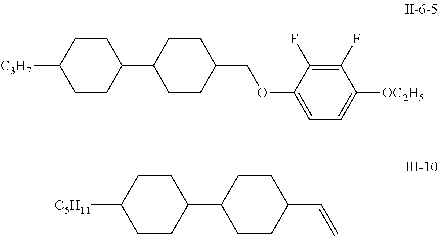

Furthermore, liquid crystal compositions comprising liquid crystal compounds II-4-5 and III-10 have been disclosed in JP2001354967A, but it requires further high-speed response. However, it is pointed out in JP2001354967A that liquid crystal compositions comprising the above alkenyl compound of III-10 tends to suffer from defects such as image retaining and display unevenness.

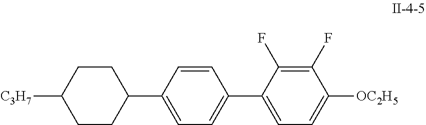

WO2007077872A1 discloses a liquid crystal composition combining the liquid crystal compound of formula (B) having a Δε of substantially zero and liquid crystal compounds II-1-3 and II-4-5. However, it is thought that the content of compound with low vapor pressures cannot be increased since compounds with low vapor pressures evaporate at extremely low pressures during the injection of liquid crystal compositions into liquid crystal cells in the manufacture of liquid crystal display elements. Thus, there are the following issues: the content of compound represented by formula (B) in the liquid crystal composition is limited; the resulting liquid crystal composition exhibits a large Δn, but the viscosity is significantly high.

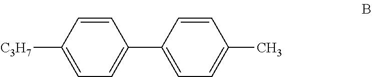

Further, liquid crystal compositions using compounds with a fluorine-substituted terphenyl structure have also been disclosed in patent literatures JP2003327965A and WO2007077872A1.

### SUMMARY OF THE INVENTION

An object of the present invention is to provide a liquid crystal composition with a negative dielectric anisotropy which has characteristics such as appropriate dielectric anisotropy, appropriate rotational viscosity, higher clearing point, wide temperature range of a nematic phase, higher optical anisotropy, good low-temperature intersolubility, higher voltage holding ratio, good high-temperature stability and good ultraviolet performance. The liquid crystal composition of the present invention avoids the impacts of exposure and/or high temperature on the liquid crystal composition, enabling the liquid crystal display comprising the liquid crystal composition of the present invention to meet the demand for normal operation in a harsh environment. Meanwhile, the liquid crystal display comprising the liquid crystal composition of the present invention has a characteristic of fast response.

The Technical Solution Employed by the Present Invention is to Provide a Liquid Crystal Composition Having a Negative Dielectric Anisotropy and Comprising:
a first component comprising one or more compounds of formula I

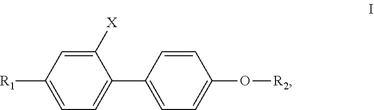

a second component comprising two or more compounds of formula II

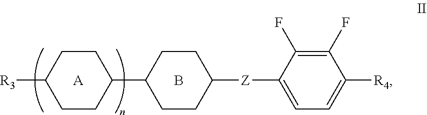

and
a third component comprising one or more compounds of formula III

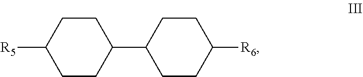

in which,
R₁, R₂, R₃, R₄, R₅ and R₆ are same or different, and each independently represents C₁-C₁₂ linear or branched alkyl or alkoxy, C₂-C₁₂ alkenyl,

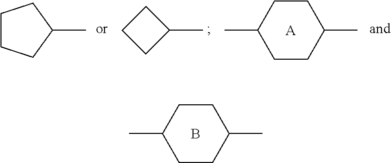

are same or different, and each independently represents

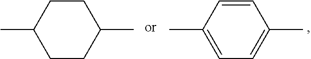

### one or two —CH₂— on the

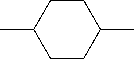

can be replaced by —O— in a manner that the oxygen atoms are not directly adjacent, one or more hydrogen atoms on the

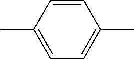

can be substituted by fluorine atom;
X represents H or halogen;
Z represents single bond, —CH₂CH₂— or —CH₂O—;
n represents 0 or 1.

In an embodiment of the present invention, for the liquid crystal composition, −8.0<Δε<−2.3, and the clearing point is ≥70° C.

In some embodiments of the present invention, it is preferred that R₁, R₂, R₃, R₄ and R₅ are same or different, and each independently represents C₁-C₅ linear or branched alkyl or alkoxy; R₆ represents C₁-C₅ linear or branched alkyl or alkoxy, or C₂-C₅ alkenyl; X represents H or F; Z represents single bond or —CH₂O—. Preferably, R₁, R₄ and R₅ are same or different, and each independently represents C₁-C₅ linear or branched alkyl; R₂ and R₃ are same or different, and each independently represents C₁-C₅ linear or branched alkyl or alkoxy; R₆ represents C₁-C₅ linear or branched alkyl, or C₂-C₅ alkenyl. More preferably, R₁, R₄ and R₅ are same or different, and each independently represents C₁-C₅ linear alkyl; R₂ and R₃ are same or different, and each independently represents C₁-C₅ linear alkyl or alkoxy; R₆ represents C₁-C₅ linear alkyl, or C₂-C₅ alkenyl.

In an embodiment of the present invention, the first component comprises 1-30% by weight of the total amount of the liquid crystal composition; the second component comprises 20-80% by weight of the total amount of the liquid crystal composition; and the third component comprises 5-50% by weight of the total amount of the liquid crystal composition.

In some embodiments of the present invention, the first component comprises one or more compounds selected from a group consisting of the following compounds:

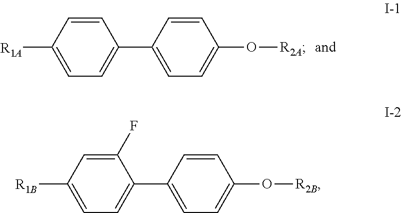

in which,
R_{1A}, R_{2A}, R_{1B} and R_{2B} are same or different, and each independently represents C₁-C₁₂ linear or branched alkyl or alkoxy, C₂-C₁₂ alkenyl,

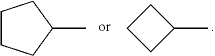

In some embodiments of the present invention, it is preferred that the compound of formula I-1 is selected from a group consisting of the following compounds:

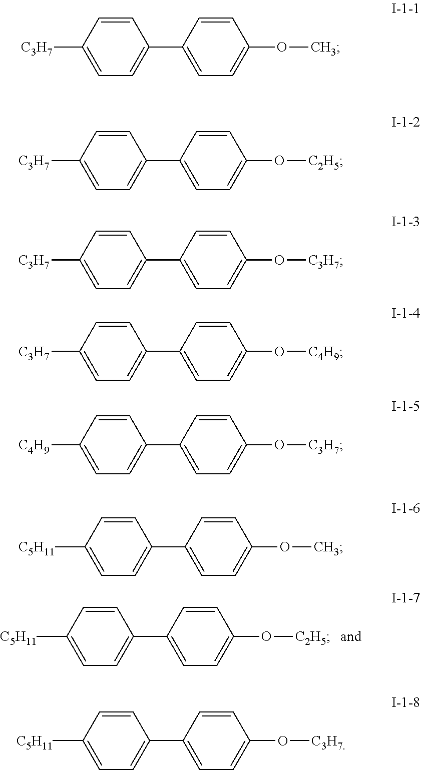

As a particularly preferred embodiment, the compound of formula I-1 is selected from a group consisting of the following compounds:

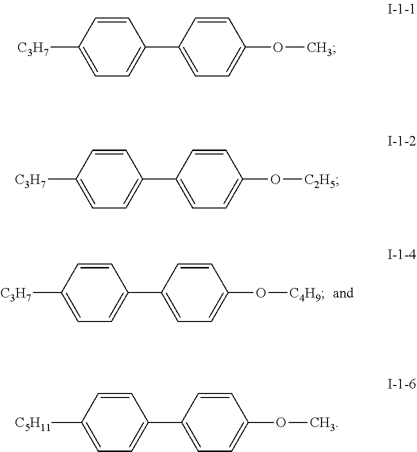

In some embodiments of the present invention, it is preferred that the compound of formula I-2 is selected from a group consisting of the following compounds:

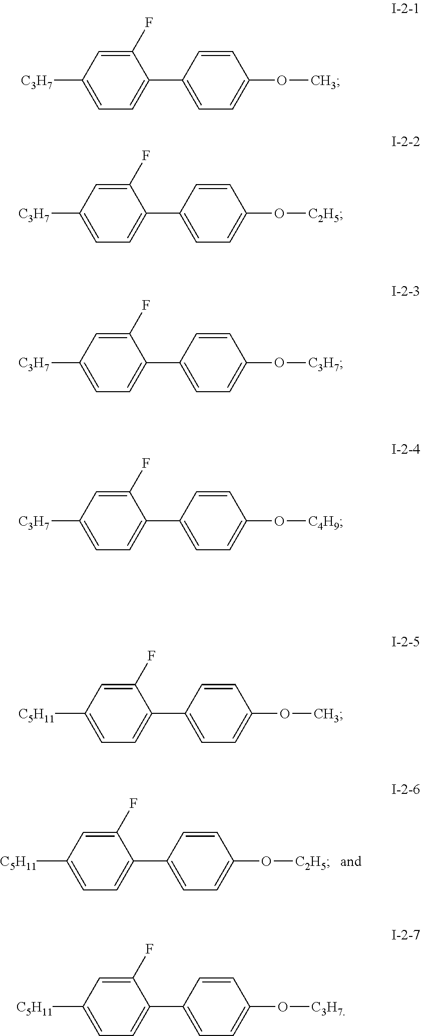

As a particularly preferred embodiment, the compound of formula I-2 is selected from a group consisting of the following compounds:

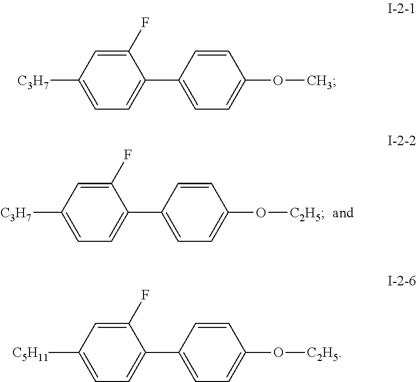

In some embodiments of the present invention, the first component consists of one or more compounds of formula I-1 and one or more compounds of formula I-2, wherein the one or more compounds of formula I-1 comprise 0-15% by weight of the total amount of the liquid crystal composition, the one or more compounds of formula I-2 comprise 0.5-15% by weight of the total amount of the liquid crystal composition, and the content of any one of the one or more compounds of formula I-1 and the one or more compounds of formula I-2 is no more than 10% by weight of the total amount of the liquid crystal composition. Preferably, the compounds of formula I-1 in the first component comprise 0-7% by weight of the total amount of the liquid crystal composition; the compounds of formula I-2 in the first component comprise 1-10% by weight of the total amount of the liquid crystal composition. More preferably, the compounds of formula I-1 in the first component comprise 3-7% by weight of the total amount of the liquid crystal composition; the compounds of formula I-2 in the first component comprise 4-10% by weight of the total amount of the liquid crystal composition.

In some embodiments of the present invention, the second component comprises one or more compounds selected from a group consisting of the following compounds:

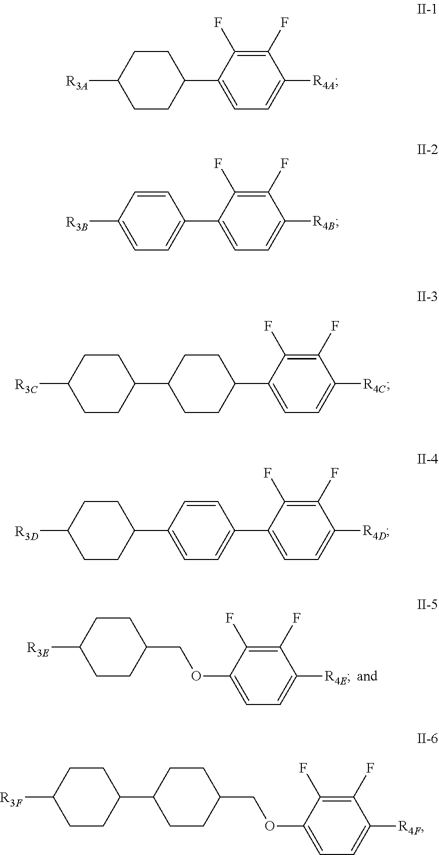

in which,
R_{3A}, R_{3B}, R_{3C}, R_{3D}, R_{3E}, R_{3F}, R_{4A}, R_{4B}, R_{4C}, R_{4D}, R_{4E} and R_{4F} are same or different, and each independently represents C₁-C₁₂ linear or branched alkyl or alkoxy, C₂-C₁₂ alkenyl,

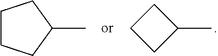

In some embodiments of the present invention, it is preferred that R_{3A}, R_{3B}, R_{3C}, R_{3D}, R_{3E}, R_{3F}, R_{4A}, R_{4B}, R_{4C}, R_{4D}, R_{4E} and R_{4F} are same or different, and each independently represents C₁-C₁₂ linear or branched alkyl or alkoxy, C₂-C₁₂ alkenyl.

More preferably, R_{3A}, R_{3B}, R_{3C}, R_{3D}, R_{3E}, R_{3F}, R_{4A}, R_{4B}, R_{4C}, R_{4D}, R_{4E} and R_{4F} are same or different, and each independently represents C₁-C₇ linear or branched alkyl or alkoxy.

In some embodiments of the present invention, it is preferred that the compound of formula II-1 is selected from a group consisting of the following compounds:

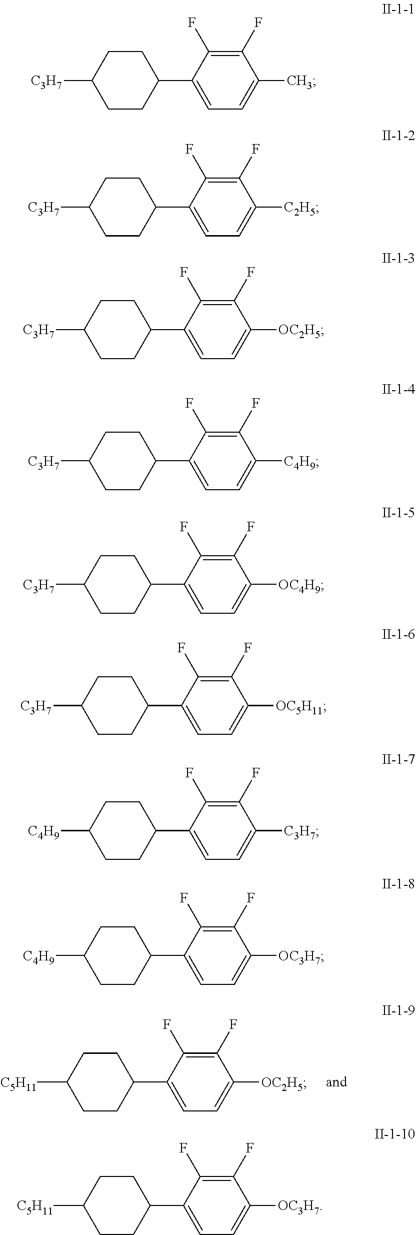

As a particularly preferred embodiment, the compound of formula II-1 is selected from a group consisting of the following compounds:

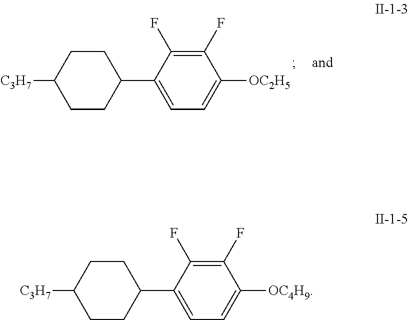

In an embodiment of the present invention, it is preferred that the compound of formula II-2 is selected from a group consisting of the following compounds:

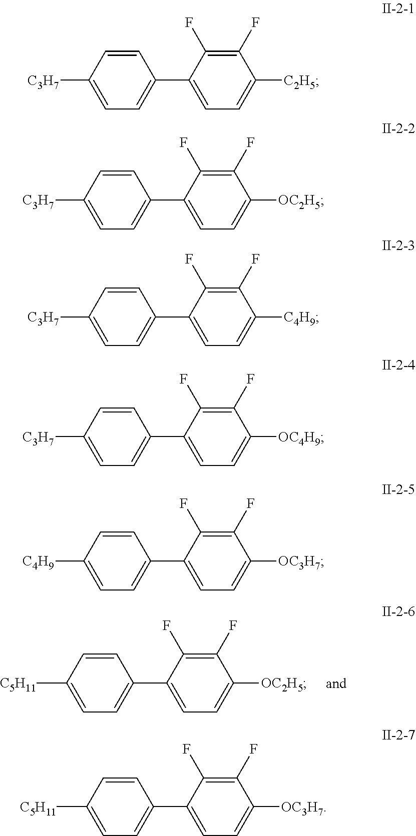

As a particularly preferred embodiment, the compound of formula II-2 is selected from a group consisting of the following compounds:

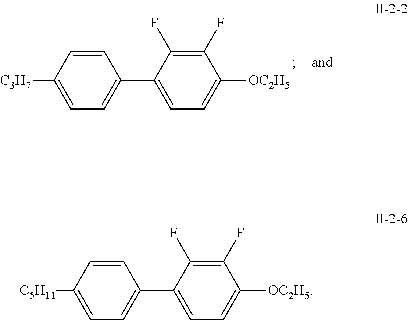

In an embodiment of the present invention, it is preferred that the compound of formula II-3 is selected from a group consisting of the following compounds:

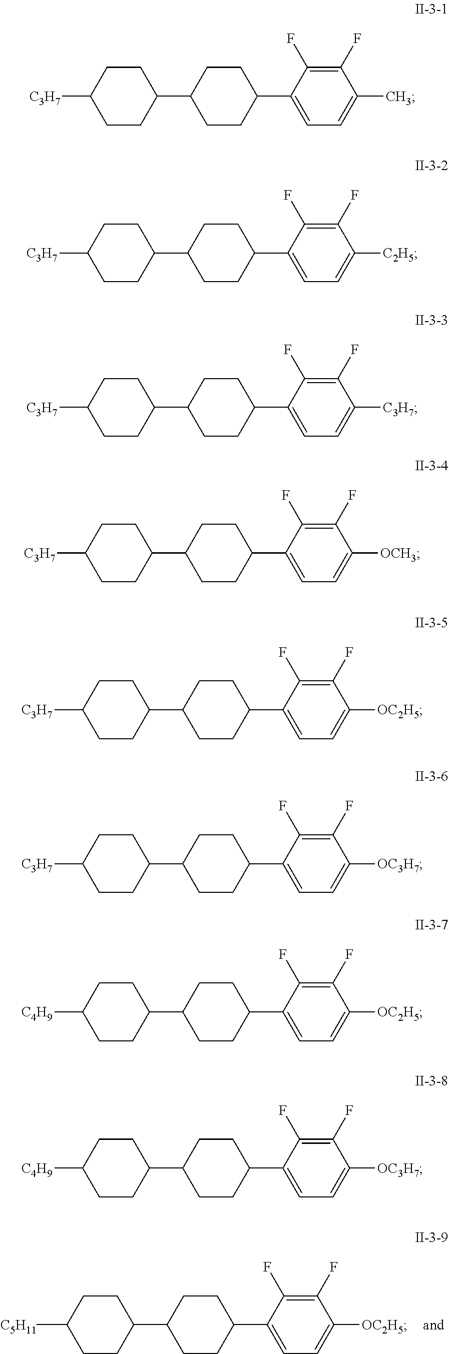

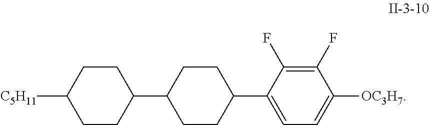

As a particularly preferred embodiment, the compound of formula II-3 is selected from a group consisting of the following compounds:

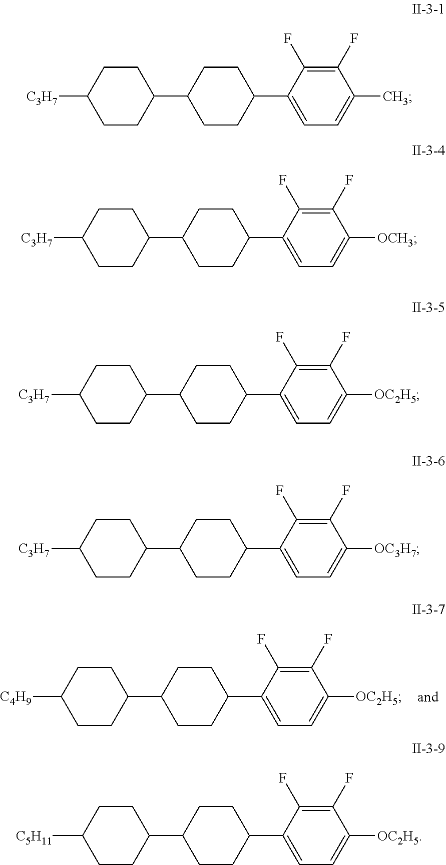

In an embodiment of the present invention, it is preferred that the compound of formula II-4 is selected from a group consisting of the following compounds:

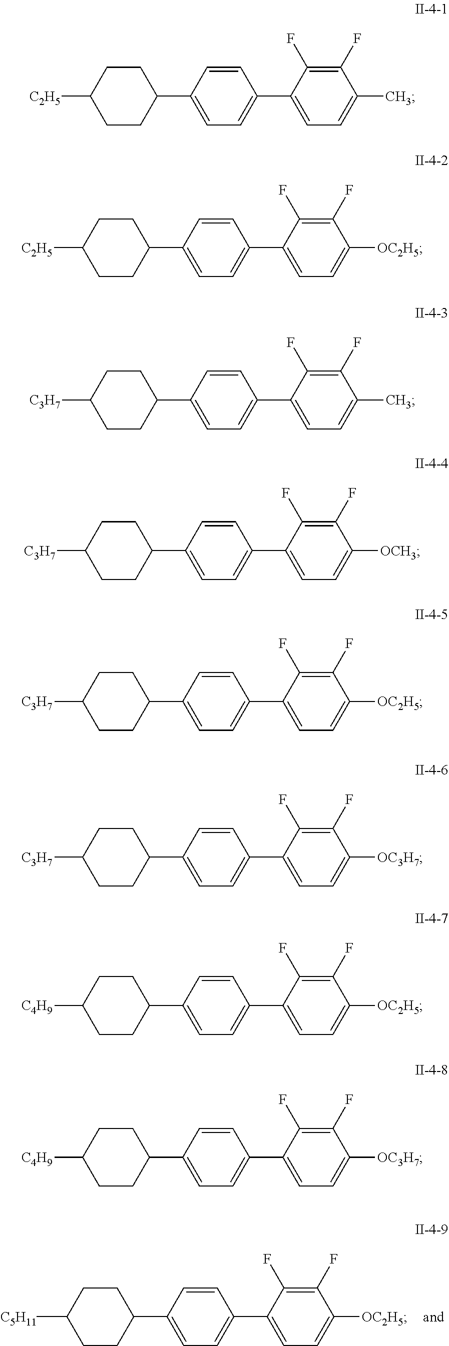

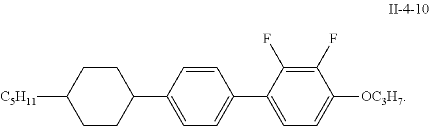

As a particularly preferred embodiment, the compound of formula II-4 is selected from a group consisting of the following compounds:

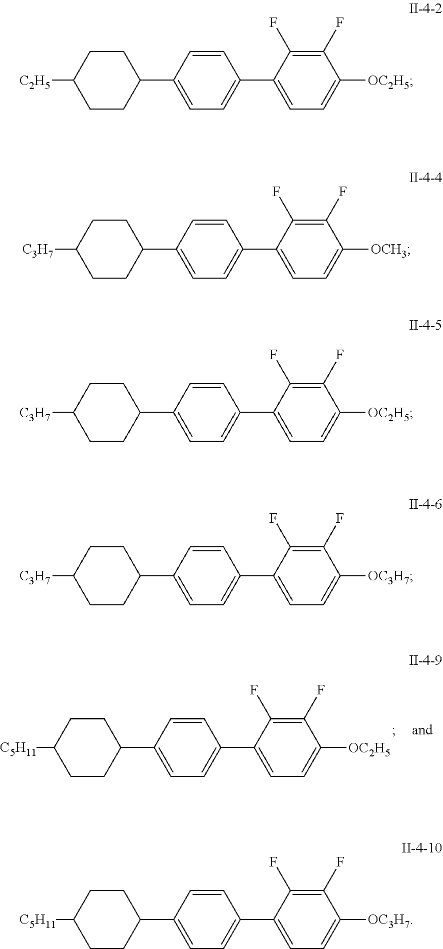

In an embodiment of the present invention, it is preferred that the compound of formula II-5 is selected from a group consisting of the following compounds:

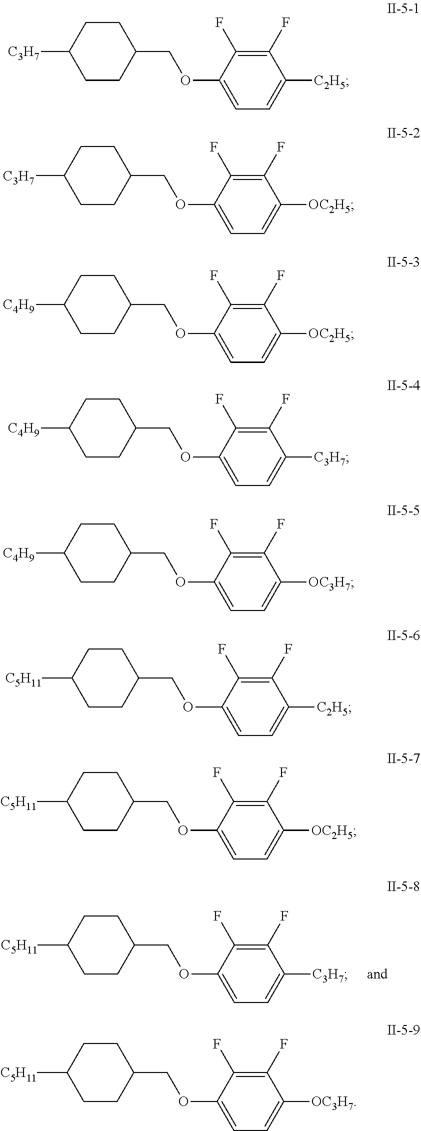

As a particularly preferred embodiment, the compound of formula II-5 is selected from a group consisting of the following compounds:

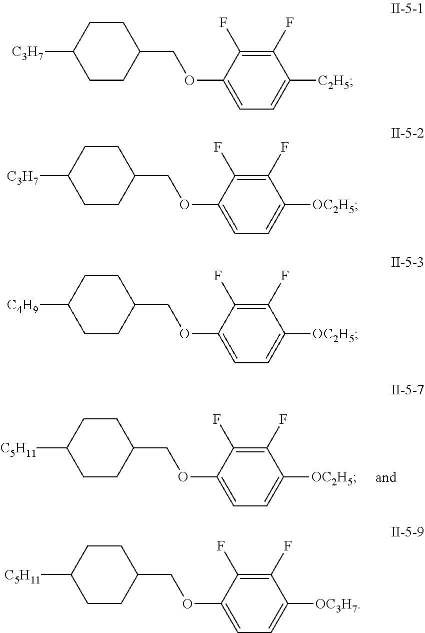

In an embodiment of the present invention, it is preferred that the compound of formula II-6 is selected from a group consisting of the following compounds:

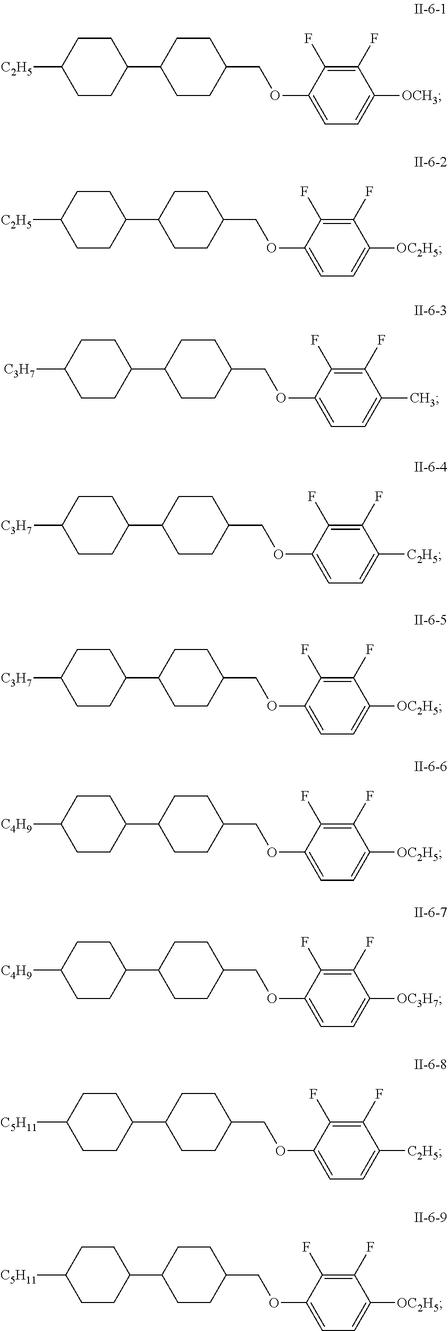

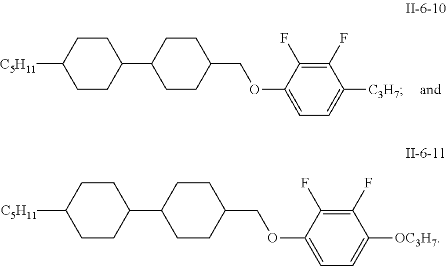

As a particularly preferred embodiment, the compound of formula II-6 is selected from a group consisting of the following compounds:

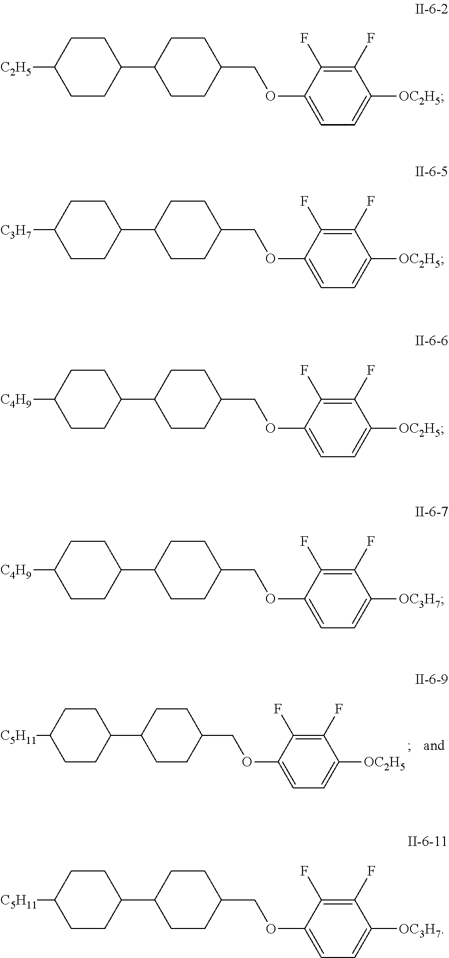

In an embodiment of the present invention, the compound of formula III is selected from a group consisting of the following compounds:

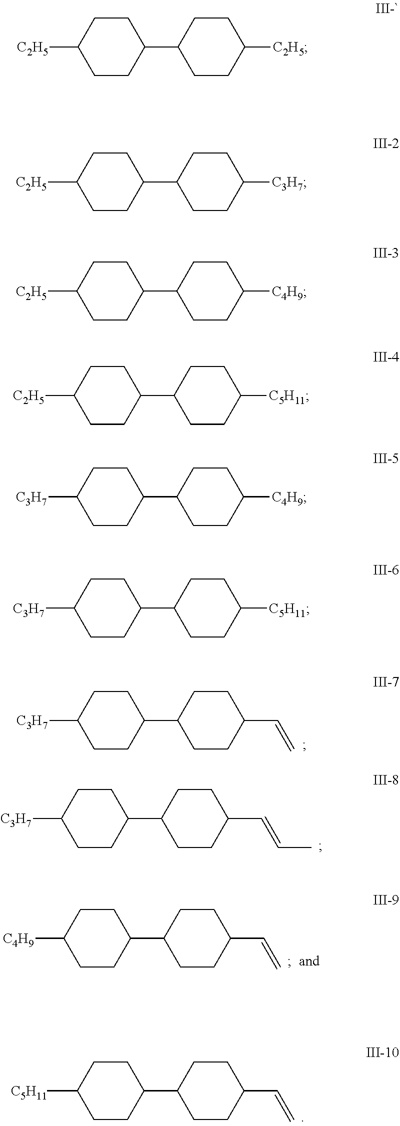

As a particularly preferred embodiment, the compound of formula III is selected from a group consisting of the following compounds:

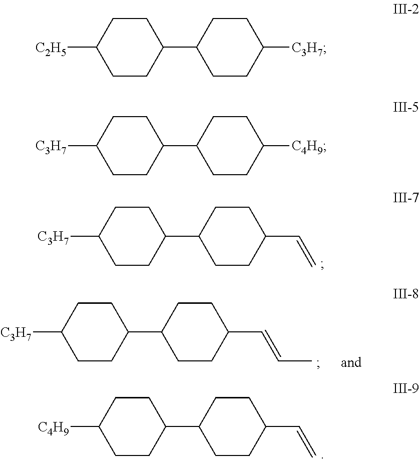

In some embodiments of the present invention, the liquid crystal composition further comprises:
a fourth component comprising one or more compounds of formula IV:

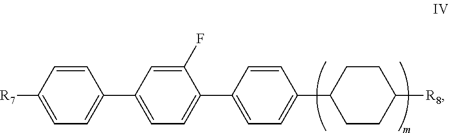

in which,
R₇ are R₈ are same or different, and each independently represents H, F, C₁-C₅ linear or branched alkyl or alkoxy, or C₂-C₅ alkenyl;
m represents 0 or 1, and when m=0, R₈ represents H or F.

In some embodiments of the present invention, it is preferred that the first component comprises 5-20% by weight of the total amount of the liquid crystal composition; the second component comprises 40-70% by weight of the total amount of the liquid crystal composition; the third component comprises 10-35% by weight of the total amount of the liquid crystal composition; and the fourth component comprises 0-10% by weight of the total amount of the liquid crystal composition.

In some embodiments of the present invention, it is preferred that the fourth component comprises one or more compounds selected from a group consisting of the following compounds:

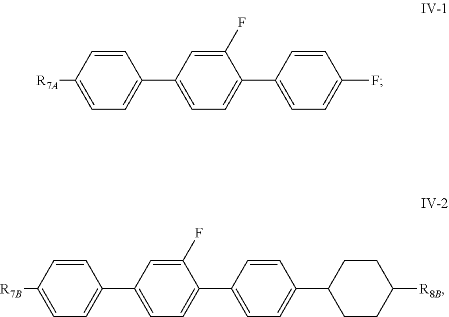

in which,
R_{7A}, R_{7B} and R_{8B} are same or different, and each independently represents C₁-C₅ alkyl or alkoxy.

In some embodiments of the present invention, the fourth component comprises 1-10% by weight of the total amount of the liquid crystal composition.

In some embodiments of the present invention, it is preferred that the content of one or more compounds conforming to formula IV-1 is no more than 5%.

In some embodiments of the present invention, it is preferred that the content of one or more compounds conforming to formula IV-2 is no more than 5%.

In an embodiment of the present invention, it is preferred that the compound of formula IV-1 is selected from a group consisting of the following compounds:

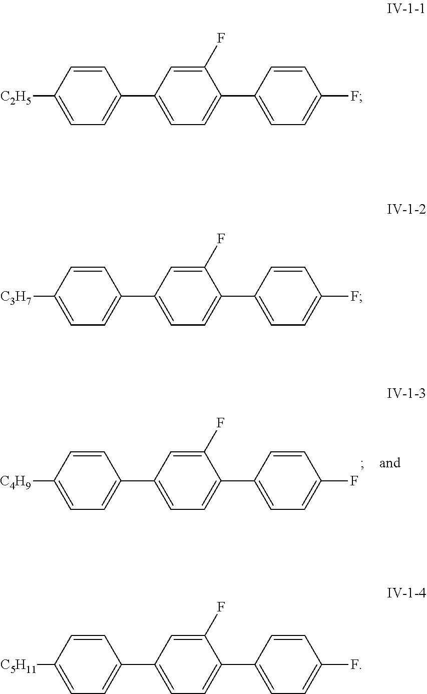

In an embodiment of the present invention, it is preferred that the compound of formula IV-2 is selected from a group consisting of the following compounds:

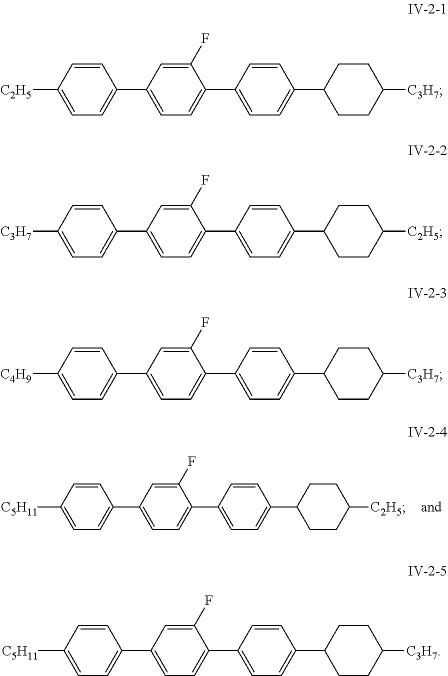

In some embodiments of the present invention, it is preferred that the first component comprises 5-12% by weight of the total amount of the liquid crystal composition; the second component comprises 49-67% by weight of the total amount of the liquid crystal composition; the third component comprises 12-33% by weight of the total amount of the liquid crystal composition; and the fourth component comprises 2-8% by weight of the total amount of the liquid crystal composition.

Based on the foregoing technical solutions of the present invention, one or more of the following compounds may also be included as a fifth component:

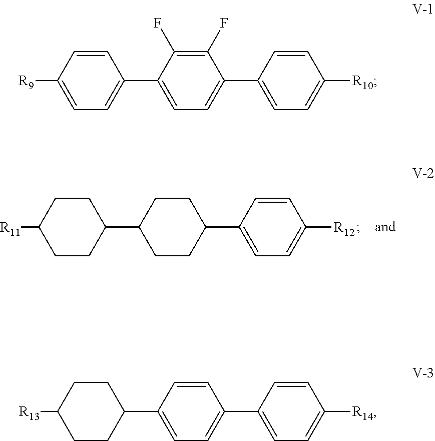

in which,
R₉, R₁₀, R₁₁, R₁₂, R₁₃ and R₁₄ are same or different, and each independently represents C₁-C₅ linear alkyl; or C₂-C₅ alkenyl.

The fifth component comprises 0-25%, preferably 0-20%, more preferably 3-20%; most preferably 5-15% by weight of the total amount of the liquid crystal composition.

Another aspect of the present invention provides a liquid crystal composition having a negative dielectric anisotropy, which further comprises one or more additives known to those skilled in the art and described in the literatures.

Stabilizers which can be added, for example, to the mixture according to the present invention are mentioned below.

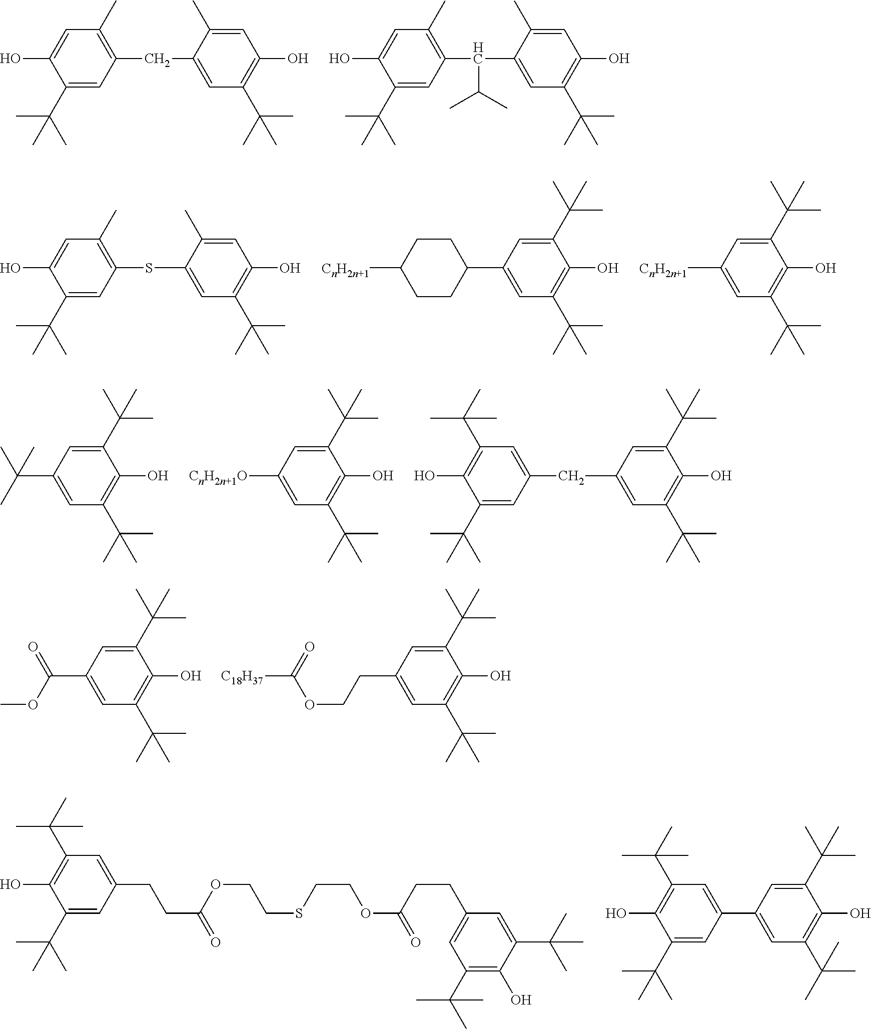

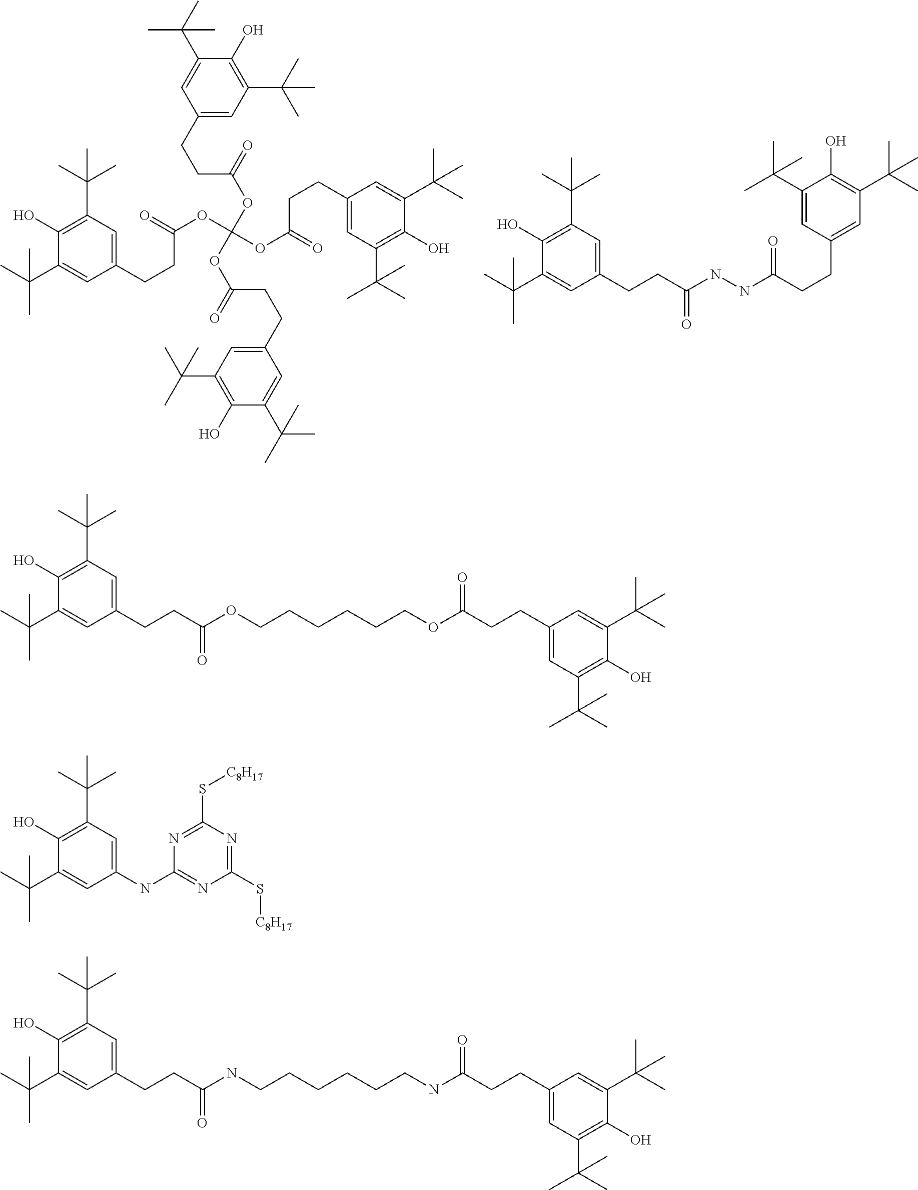

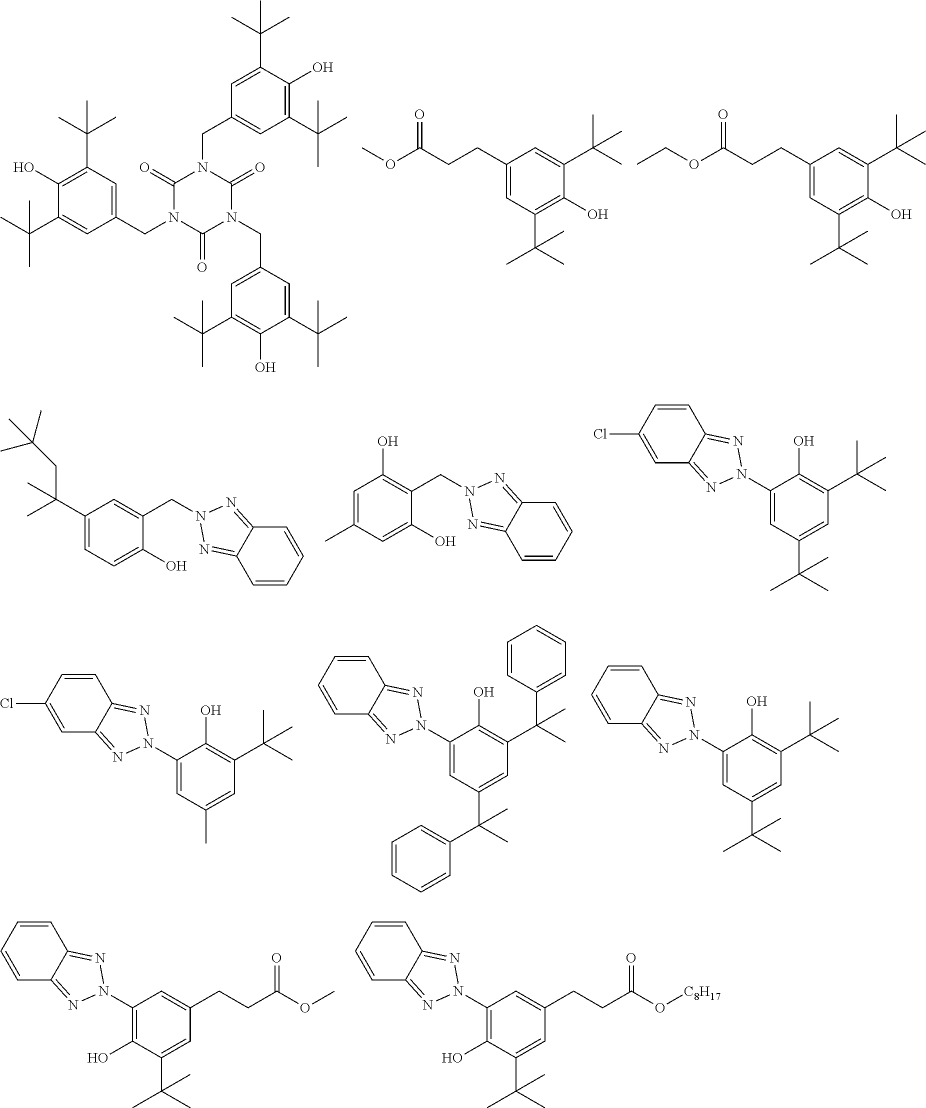

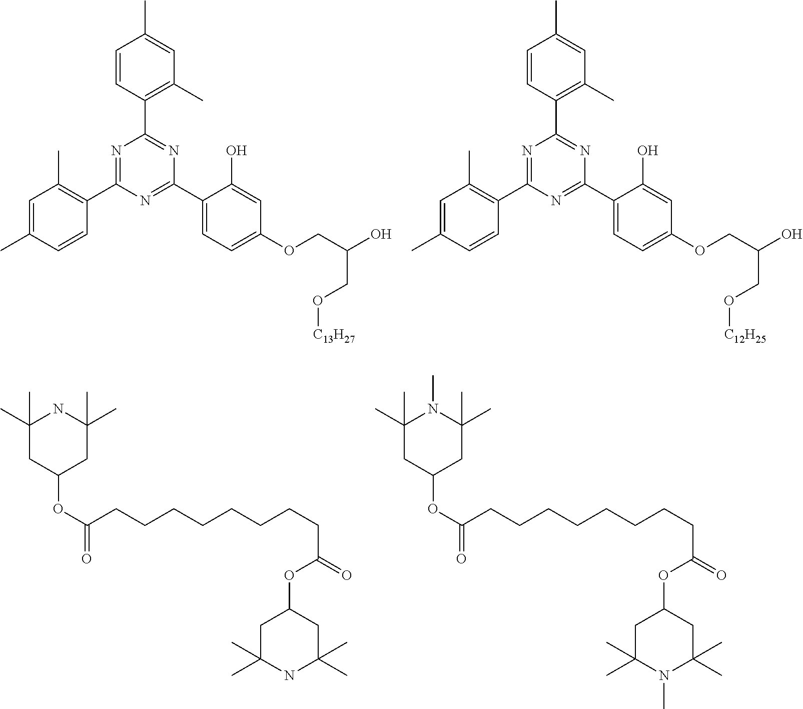

Preferably, the stabilizer is selected from a group consisting of stabilizers as shown below.

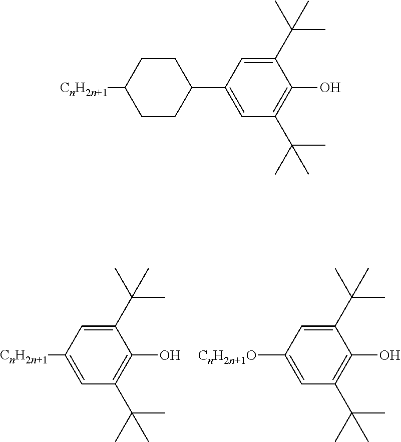

In an embodiment of the present invention, it is preferred that the stabilizer comprises 0-5% by weight of the total amount of the liquid crystal composition; more preferably, the stabilizer comprises 0-1% by weight of the total amount of the liquid crystal composition; as a particularly preferred embodiment, the stabilizer comprises 0-0.1% by weight of the total amount of the liquid crystal composition.

In still another aspect, the present invention further provides a liquid crystal display comprising the liquid crystal composition provided by the present invention.

The following technical effects are achieved by the present invention in view of the prior art by employing the technical solutions above:

The liquid crystal composition provided by the present invention has characteristics such as appropriate dielectric anisotropy, appropriate rotational viscosity, wider temperature range of a nematic phase, higher optical anisotropy, good low-temperature intersolubility, higher voltage holding ratio, good high-temperature stability and good ultraviolet performance. The liquid crystal composition of the present invention avoids the impacts of exposure and/or high temperature on the liquid crystal composition, and can meet the demand for good display effect in a harsh environment. Meanwhile, the liquid crystal composition provided by the present invention can meet the demand for rapid response of the liquid crystal display.

Unless specifically stated otherwise, in the present invention, the ratio is weight ratio, the temperature is in degree Celsius, and the test temperature of the voltage holding ratio (VHR) is 60° C.

### DETAILED EMBODIMENTS

The present invention will be illustrated by combining the detailed embodiments below. It should be noted that, the following examples are exemplary embodiments of the present invention, which are only used to illustrate the present invention, not to limit it. Other combinations and various modifications within the conception of the present invention are possible without departing from the subject matter and scope of the present invention.

For the convenience of the expression, the group structures of the liquid crystal compositions in the following Examples are represented by the codes listed in Table 1:

TABLE 1
Codes of the group structures of the liquid crystal compounds

| Unit structure of group | Code | Name of the group |
|---|---|---|
| 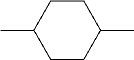 | C | 1,4-cyclohexylidene |
| 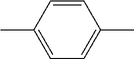 | P | 1,4-phenylene |
| 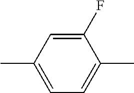 | G | 2-fluoro-1,4-phenylene |
| 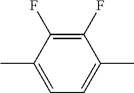 | W | 2,3-difluoro-1,4-phenylene |
| —F | F | fluorine substituent |
| —O— | O | oxygen substituent |
| —CH₂O— | 1O | methyleneoxy |
| —CH═CH— | V | alkenyl |
| —CₙH₂ₙ₊₁ or —CₘH₂ₘ₊₁ | n or m | alkyl |

Take the compound with the following structural formula as an example:

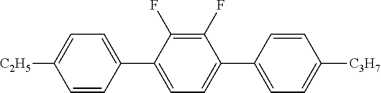

Represented by the codes listed in Table 2, this structural formula can be expressed as: 2PWP3, in which, the 2 in the code represents the left terminal is —C₂H₅, the 3 in the code represents the right terminal is —C₃H₇; the P in the code represents 1,4-phenylene; and the W represents 2,3-difluoro-1,4-phenylene.

The abbreviated codes of the test items in the following Examples are respectively represented as:
Δn: optical anisotropy (589 nm, 25° C.)
Δc: dielectric constant anisotropy (1 KHz, 25° C.)
VHR (initial): voltage holding ratio (%)
VHR (UV): voltage holding ratio after 20 min of UV lamp illumination (%)
VHR (high temperature): voltage holding ratio after holding at high temperature of 150° C. for 1 h (%)
T_{C-N} (° C.): low-temperature phase transformation point (the transformation temperature from other more ordered phases to a nematic phase)
T_{N-I} (° C.): clearing point (the transformation temperature of the liquid crystal from a nematic phase to an isotropy phase)
γ1: rotational viscosity (mPa*s, at 20° C.)

In which, the optical anisotropy is tested and obtained by using abbe refractometer under sodium lamp (589 nm) light source at 25° C.; the dielectric test cell is the TN90 type with a cell gap of 7 μm.

Δε=ε∥−ε⊥, in which, ε| is a dielectric constant parallel to the molecular axis, ε⊥ is a dielectric constant perpendicular to the molecular axis, with the test conditions: 25° C., 1 KHz, TN90 type test cell with a cell gap of 7 μm.

VHR (initial) is tested and obtained by the TOY06254 type liquid crystal physical property evaluation system; the test temperature is 60° C., the test voltage is 5 V, and the test frequency is 6 Hz.

VHR (UV) is tested and obtained by the TOY06254 type liquid crystal physical property evaluation system; the liquid crystal is tested after being irradiated with light having a wavelength of 365 nm and an energy of 6000 mJ/cm² for 20 mins, the test temperature is 60° C., the test voltage is 5 V, and the test frequency is 6 Hz.

VHR (high temperature) is tested and obtained by the TOY06254 type liquid crystal physical property evaluation system; the liquid crystal is tested after being held at a high temperature of 150° C. for 1 h, the test temperature is 60° C., the test voltage is 5 V, and the test frequency is 6 Hz.

γ1 is tested and obtained by the TOY06254 type liquid crystal physical property evaluation system; the test temperature is 25° C., and the test voltage is 90 V.

The ingredients used in the following Examples can be synthesized by well-known methods or obtained by commercial means. These synthetic techniques are routine, and the test results show that the liquid crystal compounds thus prepared meet the criteria for the electronic compounds.

Several liquid crystal compositions are prepared according to the formulations of the liquid crystal compositions specified in the following Examples. The preparation of the liquid crystal compositions is proceeded according to the conventional methods in the art, and as an example, the compositions are prepared by mixing the specified formulation via the processing modes, such as heating, ultrasonic processing, suspending processing and so on.

### Comparative Example 1

The liquid crystal composition of Comparative Example 1 is prepared according to each compound and weight percentage listed in Table 2 and then tested by filling the same between two substrates of a liquid crystal display. The test data is shown in the Table below:

TABLE 2
Formulation of the liquid crystal composition
and the test performances thereof

| Monomer | Compound | Weight | Test results for the | |
|---|---|---|---|---|
| Name | No. | Percentage | performance parameters | |
| 5PP1 | | 8 | Δn: | 0.102 |
| 3CWO2 | II -1-3 | 7 | Δε: | −2.9 |
| 3CWO4 | II -1-5 | 8 | VHR (initial): | 91.4 |
| 2CPWO2 | II -4-2 | 6 | VHR (UV): | 84.5 |
| 3CPWO2 | II -4-5 | 7 | VHR (high | 91.3 |
| | | | temperature): | |
| 3CCWO3 | II -3-6 | 7 | T_{C—N} (° C.): | −32 |
| 4CCWO2 | II -3-7 | 7 | T_{N—I} (° C.): | 75 |
| 5CCWO2 | II -3-9 | 7 | γ1: | 111 |
| 3CC2 | III-2 | 22 | | |
| 3CC4 | III-5 | 11 | | |
| 3PWP2 | V -1 | 4 | | |
| 4PWP2 | V -1 | 4 | | |
| 3CCP1 | V -2 | 2 | | |

| | |
|---|---|
| Total | 100 |

### Example 1

The liquid crystal composition of Example 1 is prepared according to each compound and weight percentage listed in Table 3 and then tested by filling the same between two substrates of a liquid crystal display. The test data is shown in the Table below:

TABLE 3
Formulation of the liquid crystal composition
and the test performances thereof

| Monomer | Compound | Weight | Test results for the | |
|---|---|---|---|---|
| Name | No. | Percentage | performance parameters | |
| 3PPO2 | I -1-2 | 4 | Δn: | 0.108 |
| 3GPO2 | I -2-2 | 4 | Δε: | −3.1 |
| 3CWO2 | II -1-3 | 7 | VHR (initial): | 92.6 |
| 3CWO4 | II -1-5 | 8 | VHR (UV): | 86.9 |
| 2CPWO2 | II -4-2 | 6 | VHR (high | 92.5 |
| | | | temperature): | |
| 3CPWO2 | II -4-5 | 7 | T_{C—N} (° C.): | −37 |
| 3CCWO3 | II -3-6 | 7 | T_{N—I} (° C.): | 77 |
| 4CCWO2 | II -3-7 | 7 | γ1: | 111 |
| 5CCWO2 | II -3-9 | 7 | | |
| 3CC2 | III-2 | 22 | | |
| 3CC4 | III-5 | 11 | | |
| 3PWP2 | V -1 | 4 | | |
| 4PWP2 | V -1 | 4 | | |
| 3CCP1 | V -2 | 2 | | |

| | |
|---|---|
| Total | 100 |

### Example 2

The liquid crystal composition of Example 2 is prepared according to each compound and weight percentage listed in Table 4 and then tested by filling the same between two substrates of a liquid crystal display. The test data is shown in the Table below:

TABLE 4
Formulation of the liquid crystal composition and the test performances
thereof

| Monomer | Compound | Weight | Test results for the | |
|---|---|---|---|---|
| Name | No. | Percentage | performance parameters | |
| 3PPO2 | I -1-2 | 4 | Δn: | 0.106 |
| 3GPO2 | I -2-2 | 8 | Δε: | −2.9 |
| 3CWO2 | II -1-3 | 7 | VHR (initial): | 94.2 |
| 3CWO4 | II -1-5 | 8 | VHR (UV): | 91.1 |
| 2CPWO2 | II -4-2 | 6 | VHR (high | 93.9 |
| | | | temperature): | |
| 3CPWO2 | II -4-5 | 7 | T_{C—N} (° C.): | −37 |
| 3CCWO3 | II -3-6 | 7 | T_{N—I} (° C.): | 77 |
| 4CCWO2 | II -3-7 | 7 | γ1: | 101 |
| 5CCWO2 | II -3-9 | 7 | | |
| 3CC2 | III-2 | 22 | | |
| 3CC4 | III-5 | 11 | | |
| 3PWP2 | V -1 | 2 | | |
| 4PWP2 | V -1 | 2 | | |
| 3CCP1 | V -2 | 2 | | |

| | |
|---|---|
| Total | 100 |

### Comparative Example 2

The liquid crystal composition of Comparative Example 2 is prepared according to each compound and weight percentage listed in Table 5 and then tested by filling the same between two substrates of a liquid crystal display. The test data is shown in the Table below:

TABLE 5
Formulation of the liquid crystal composition
and the test performances thereof

| Monomer | Compound | Weight | Test results for the | |
|---|---|---|---|---|
| Name | No. | Percentage | performance parameters | |
| 4PP1 | | 7 | Δn: | 0.151 |
| 3PWO2 | II -2-2 | 19 | Δε: | −3.6 |
| 5PWO2 | II -2-6 | 17 | VHR (initial): | 89.5 |
| 2CPWO2 | II -4-2 | 12 | VHR (UV): | 81.3 |
| 3CPWO2 | II -4-5 | 13 | VHR (high | 89.3 |
| | | | temperature): | |
| 3CCV1 | III-8 | 12 | T_{C—N} (° C.): | −31 |
| VCCP1 | V -2 | 10 | T_{N—I} (° C.): | 72 |
| 3CPP2 | V -3 | 10 | γ1: | 143 |

| | |
|---|---|
| Total | 100 |

### Example 3

The liquid crystal composition of Example 3 is prepared according to each compound and weight percentage listed in Table 6 and then tested by filling the same between two substrates of a liquid crystal display. The test data is shown in the Table below:

TABLE 6
Formulation of the liquid crystal composition
and the test performances thereof

| Monomer | Compound | Weight | Test results for the | |
|---|---|---|---|---|
| Name | No. | Percentage | performance parameters | |
| 3GPO2 | I -2-2 | 9 | Δn: | 0.157 |
| 3PWO2 | II -2-2 | 17 | Δε: | −3.5 |
| 5PWO2 | II -2-6 | 17 | VHR (initial): | 91.1 |
| 2CPWO2 | II -4-2 | 12 | VHR (UV): | 82.4 |
| 3CPWO2 | II -4-5 | 13 | VHR (high | 90.6 |
| | | | temperature): | |
| 3CCV1 | III-8 | 12 | T_{C—N} (° C.): | −38 |
| VCCP1 | V -2 | 10 | T_{N—I} (° C.): | 77 |
| 3CPP2 | V -3 | 10 | γ1: | 138 |

| | |
|---|---|
| Total | 100 |

### Example 4

The liquid crystal composition of Example 4 is prepared according to each compound and weight percentage listed in Table 7 and then tested by filling the same between two substrates of a liquid crystal display. The test data is shown in the Table below:

TABLE 7
Formulation of the liquid crystal composition
and the test performances thereof

| Monomer | Compound | Weight | Test results for the | |
|---|---|---|---|---|
| Name | No. | Percentage | performance parameters | |
| 3GPO2 | I -2-2 | 6 | Δn: | 0.167 |
| 3PPO2 | I -1-2 | 3 | Δε: | −3.4 |
| 3PWO2 | II -2-2 | 17 | VHR (initial): | 91.3 |
| 5PWO2 | II -2-6 | 17 | VHR (UV): | 82.6 |
| 2CPWO2 | II -4-2 | 12 | VHR (high | 91.1 |
| | | | temperature): | |
| 3CPWO2 | II -4-5 | 13 | T_{C—N} (° C.): | −37 |
| 3CCV1 | III-8 | 12 | T_{N—I} (° C.): | 80 |
| VCCP1 | V -2 | 6 | γ1: | 145 |
| 3CPP2 | V -3 | 6 | | |
| 3PGPF | IV-1-3 | 3.5 | | |
| 3PGPC2 | IV-2-2 | 4.5 | | |

| | |
|---|---|
| Total | 100 |

### Comparative Example 3

The liquid crystal composition of Comparative Example 3 is prepared according to each compound and weight percentage listed in Table 8 and then tested by filling the same between two substrates of a liquid crystal display. The test data is shown in the Table below:

TABLE 8
Formulation of the liquid crystal composition
and the test performances thereof

| Monomer | Compound | Weight | Test results for the | |
|---|---|---|---|---|
| Name | No. | Percentage | performance parameters | |
| 3PP1 | | 7 | Δn: | 0.110 |
| 4PP1 | | 7 | Δε: | −3.7 |
| 3CCWO1 | II -3-4 | 5 | VHR (initial): | 91.2 |
| 3CCWO2 | II -3-5 | 7 | VHR (UV): | 82.5 |
| 3CCWO3 | II -3-6 | 12 | VHR (high | 90.8 |
| | | | temperature): | |
| 4CCWO2 | II -3-7 | 8 | T_{C—N} (° C.): | −27 |
| 2CPWO2 | II -4-2 | 9.5 | T_{N—I} (° C.): | 80 |
| 3CPWO2 | II -4-5 | 10 | γ1: | 117 |
| 3CWO2 | II -1-3 | 12 | | |
| 3CWO4 | II -1-5 | 3.5 | | |
| 3CCV | III-7 | 19 | | |

| | |
|---|---|
| Total | 100 |

### Example 5

The liquid crystal composition of Example 5 is prepared according to each compound and weight percentage listed in Table 9 and then tested by filling the same between two substrates of a liquid crystal display. The test data is shown in the Table below:

TABLE 9
Formulation of the liquid crystal composition
and the test performances thereof

| Monomer | Compound | Weight | Test results for the | |
|---|---|---|---|---|
| Name | No. | Percentage | performance parameters | |
| 3PPO4 | I -1-4 | 7 | Δn: | 0.117 |
| 3GPO2 | I -2-2 | 7 | Δε: | −3.6 |
| 3CCWO1 | II -3-4 | 6 | VHR (initial): | 92.8 |
| 3CCWO2 | II -3-5 | 6 | VHR (UV): | 85.1 |
| 3CCWO3 | II -3-6 | 10 | VHR (high | 92.1 |
| | | | temperature): | |
| 4CCWO2 | II -3-7 | 10 | T_{C—N} (° C.): | −37 |
| 2CPWO2 | II -4-2 | 9.5 | T_{N—I} (° C.): | 85 |
| 3CPWO2 | II -4-5 | 10 | γ1: | 119 |
| 3CWO2 | II -1-3 | 8 | | |
| 3CWO4 | II -1-5 | 7.5 | | |
| 3CCV | III-7 | 19 | | |

| | |
|---|---|
| Total | 100 |

### Comparative Example 4

The liquid crystal composition of Comparative Example 4 is prepared according to each compound and weight percentage listed in Table 10 and then tested by filling the same between two substrates of a liquid crystal display. The test data is shown in the Table below:

TABLE 10
Formulation of the liquid crystal composition
and the test performances thereof

| Monomer | Compound | Weight | Test results for the | |
|---|---|---|---|---|
| Name | No. | Percentage | performance parameters | |
| 2CPWO2 | II -4-2 | 5 | Δn: | 0.110 |
| 3CPWO2 | II -4-5 | 6.5 | Δε: | −4.7 |
| 3C1OWO2 | II -5-2 | 9 | VHR (initial): | 88.9 |
| 3CPWO3 | II -4-6 | 5.5 | VHR (UV): | 84.3 |
| 2CC1OWO2 | II -6-2 | 8.5 | VHR (high | 88.6 |
| | | | temperature): | |
| 3CC1OWO2 | II -6-5 | 4 | T_{C—N} (° C.): | −32 |
| 3CCWO2 | II -3-5 | 10 | T_{N—I} (° C.): | 91 |
| 4CCWO2 | II -3-7 | 9 | γ1: | 108 |
| 4C1OWO2 | II -5-3 | 8.5 | | |
| 3CC2 | III-2 | 8.5 | | |
| 4CC3 | III-5 | 8.5 | | |
| 3CCP1 | V -2 | 7.5 | | |
| 5PP1 | | 9.5 | | |

| | |
|---|---|
| Total | 100 |

### Example 6

The liquid crystal composition of Example 6 is prepared according to each compound and weight percentage listed in Table 11 and then tested by filling the same between two substrates of a liquid crystal display. The test data is shown in the Table below:

TABLE 11
Formulation of the liquid crystal composition
and the test performances thereof

| Monomer | Compound | Weight | Test results for the | |
|---|---|---|---|---|
| Name | No. | Percentage | performance parameters | |
| 2CPWO2 | II -4-2 | 5 | Δn: | 0.117 |
| 3CPWO2 | II -4-5 | 6.5 | Δε: | −4.8 |
| 3C1OWO2 | II -5-2 | 9 | VHR (initial): | 90.1 |
| 3CPWO3 | II -4-6 | 5.5 | VHR (UV): | 86.3 |
| 2CC1OWO2 | II -6-2 | 8.5 | VHR (high | 89.7 |
| | | | temperature): | |
| 3CC1OWO2 | II -6-5 | 4 | T_{C—N} (° C.): | −39 |
| 3CCWO2 | II -3-5 | 10 | T_{N—I} (° C.): | 93 |
| 4CCWO2 | II -3-7 | 9 | γ1: | 109 |
| 4C1OWO2 | II -5-3 | 8.5 | | |
| 3CC2 | III-2 | 8.5 | | |
| 4CC3 | III-5 | 8.5 | | |
| 3CCP1 | V -2 | 7.5 | | |
| 3PPO2 | I -1-2 | 3.5 | | |
| 3GPO2 | I -2-2 | 6 | | |

| | |
|---|---|
| Total | 100 |

### Example 7

The liquid crystal composition of Example 7 is prepared according to each compound and weight percentage listed in Table 12 and then tested by filling the same between two substrates of a liquid crystal display. The test data is shown in the Table below:

TABLE 12
Formulation of the liquid crystal composition
and the test performances thereof

| Monomer | Compound | Weight | Test results for the | |
|---|---|---|---|---|
| Name | No. | Percentage | performance parameters | |
| 2CPWO2 | II -4-2 | 5 | Δn: | 0.117 |
| 3CPWO2 | II -4-5 | 6.5 | Δε: | −4.8 |
| 3C1OWO2 | II -5-2 | 9 | VHR (initial): | 90.2 |
| 3CPWO3 | II -4-6 | 5.5 | VHR (UV): | 86.2 |
| 2CC1OWO2 | II -6-2 | 8.5 | VHR (high | 90.1 |
| | | | temperature): | |
| 3CC1OWO2 | II -6-5 | 4 | T_{C—N} (° C.): | −44 |
| 3CCWO2 | II -3-5 | 10 | T_{N—I} (° C.): | 93 |
| 4CCWO2 | II -3-7 | 9 | γ1: | 109 |
| 4C1OWO2 | II -5-3 | 8.5 | | |
| 3CC2 | III-2 | 8.5 | | |
| 4CC3 | III-5 | 8.5 | | |
| 3CCP1 | V -2 | 7.5 | | |
| 3GPO2 | I -2-2 | 9.5 | | |

| | |
|---|---|
| Total | 100 |

### Example 8

The liquid crystal composition of Example 8 is prepared according to each compound and weight percentage listed in Table 13 and then tested by filling the same between two substrates of a liquid crystal display. The test data is shown in the Table below:

TABLE 13
Formulation of the liquid crystal composition
and the test performances thereof

| Monomer | Compound | Weight | Test results for the | |
|---|---|---|---|---|
| Name | No. | Percentage | performance parameters | |
| 2CPWO2 | II -4-2 | 5 | Δn: | 0.120 |
| 3CPWO2 | II -4-5 | 6.5 | Δε: | −4.7 |
| 3C1OWO2 | II -5-2 | 9 | VHR (initial): | 91.2 |
| 3CPWO3 | II -4-6 | 5.5 | VHR (UV): | 88.9 |
| 2CC1OWO2 | II -6-2 | 8.5 | VHR (high | 90.5 |
| | | | temperature): | |
| 3CC1OWO2 | II -6-5 | 4 | T_{C—N} (° C.): | −39 |
| 3CCWO2 | II -3-5 | 10 | T_{N—I} (° C.): | 98 |
| 4CCWO2 | II -3-7 | 9 | γ1: | 111 |
| 4C1OWO2 | II -5-3 | 8.5 | | |
| 3CC2 | III-2 | 8.5 | | |
| 4CC3 | III-5 | 8.5 | | |
| 3CCP1 | V -2 | 3 | | |
| 3GPO2 | I -2-2 | 9.5 | | |
| 3PGPF | IV-1-3 | 1.5 | | |
| 3PGPC2 | IV-2-2 | 3 | | |

| | |
|---|---|
| Total | 100 |

### Comparative Example 5

The liquid crystal composition of Comparative Example 5 is prepared according to each compound and weight percentage listed in Table 14 and then tested by filling the same between two substrates of a liquid crystal display. The test data is shown in the Table below:

TABLE 14
Formulation of the liquid crystal composition
and the test performances thereof

| Monomer | Compound | Weight | Test results for the | |
|---|---|---|---|---|
| Name | No. | Percentage | performance parameters | |
| 3CPWO2 | II -4-5 | 8.5 | Δn: | 0.110 |
| 3CWO4 | II -1-5 | 30 | Δε: | −3.5 |
| 3CCWO2 | II -3-5 | 5 | VHR (initial): | 90.9 |
| 5CCWO2 | II -3-9 | 5 | VHR (UV): | 85.5 |
| 4CCWO2 | II -3-7 | 5 | VHR (high | 90.6 |
| | | | temperature): | |
| 3CCWO3 | II -3-6 | 5 | T_{C—N} (° C.): | −37 |
| 3CCW1 | II -3-1 | 6 | T_{N—I} (° C.): | 88 |
| 2PWP3 | V -1 | 6 | γ1: | 127 |
| 2PWP4 | V -1 | 4.5 | | |
| VCCP1 | V -2 | 13 | | |
| 4CCV | III-9 | 6 | | |
| 3CCV1 | III-8 | 6 | | |

| | |
|---|---|
| Total | 100 |

### Example 9

The liquid crystal composition of Example 9 is prepared according to each compound and weight percentage listed in Table 15 and then tested by filling the same between two substrates of a liquid crystal display. The test data is shown in the Table below:

TABLE 15
Formulation of the liquid crystal composition
and the test performances thereof

| Monomer | Compound | Weight | Test results for the | |
|---|---|---|---|---|
| Name | No. | Percentage | performance parameters | |
| 3CPWO2 | II -4-5 | 8.5 | Δn: | 0.114 |
| 3CWO4 | II -1-5 | 30 | Δε: | −3.3 |
| 3CCWO2 | II -3-5 | 5 | VHR (initial): | 94.5 |
| 5CCWO2 | II -3-9 | 5 | VHR (UV): | 92.2 |
| 4CCWO2 | II -3-7 | 5 | VHR (high | 94.2 |
| | | | temperature): | |
| 3CCWO3 | II -3-6 | 5 | T_{C—N} (° C.): | −42 |
| 3CCW1 | II -3-1 | 6 | T_{N—I} (° C.): | 90 |
| VCCP1 | V -2 | 13 | γ1: | 119 |
| 4CCV | III-9 | 6 | | |
| 3CCV1 | III-8 | 6 | | |
| 3GPO2 | I -2-2 | 5.5 | | |
| 3PGPC2 | IV-2-2 | 5 | | |

| | |
|---|---|
| Total | 100 |

As can be known from the data of the Comparative Examples and Examples above, the liquid crystal composition provided by the present invention has higher optical anisotropy value, lower low-temperature phase transformation point and higher clearing point, indicating that the liquid crystal composition provided by the present invention has the characteristic of wide temperature range of the nematic phase. Meanwhile, the liquid crystal composition of the present invention also has higher voltage holding ratio, better high-temperature and ultraviolet stability, and the liquid crystal display comprising the liquid crystal composition of the present invention can meet the demand for rapid response speed and has higher stability. The liquid crystal composition of the present invention avoids the impacts of exposure and/or high temperature on the liquid crystal composition, and can meet the demand for the liquid crystal display being in normal operation in a harsh environment.

The above embodiments are merely illustrative of the technical concepts and features of the present invention, and provided for facilitating the understanding and practice of the present invention by those skilled in the art. However, the protection scope of the invention is not limited thereto. Equivalent variations or modifications made without departing from the spirit and essence of the present invention are intended to be contemplated within the protection scope of the present invention.

1. A liquid crystal composition having negative dielectric anisotropy, the liquid crystal composition comprising:
a first component comprising one or more compounds of formula I 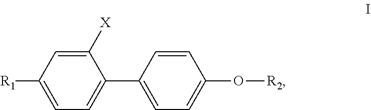
a second component comprising two or more compounds of formula II 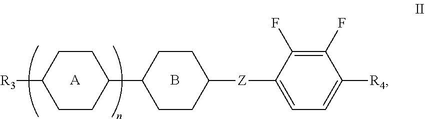
and
a third component comprising one or more compounds of formula III 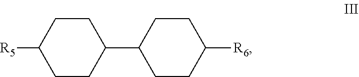
in which,
R₁, R₂, R₃, R₄, R₅ and R₆ are same or different, and each independently represents C₁-C₁₂ linear or branched alkyl or alkoxy, C₂-C₁₂ alkenyl, 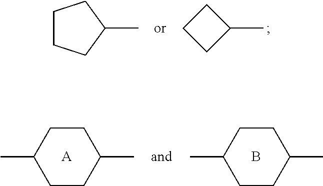
are same or different, and each independently represents 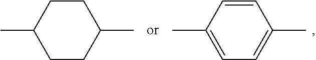
one or two —CH₂— on the 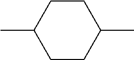
can be replaced by —O— in a manner that the oxygen atoms are not directly adjacent, one or more hydrogen atoms on the 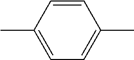
can be substituted by fluorine atom;
X represents H or halogen;
Z represents single bond, —CH₂CH₂— or —CH₂O—;
n represents 0 or 1.

2. The liquid crystal composition according to claim 1, wherein
the first component comprises one or more compounds selected from a group consisting of the following compounds: 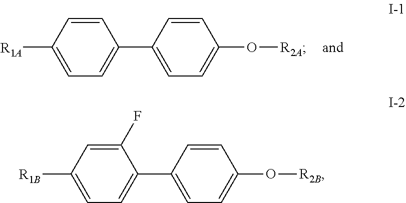
in which,
R_{1A}, R_{2A}, R_{1B} and R_{2B} are same or different, and each independently represents C₁-C₁₂ linear or branched alkyl or alkoxy, C₂-C₁₂ alkenyl,

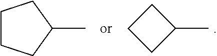

3. The liquid crystal composition according to claim 1, wherein R₁, R₂, R₃, R₄ and R₅ are same or different, and each independently represents C₁-C₅ linear or branched alkyl or alkoxy; the R₆ represents C₁-C₅ linear or branched alkyl or alkoxy, or C₂-C₅ alkenyl; the X represents H or F; the Z represents single bond or —CH₂O—.

4. The liquid crystal composition according to claim 1, wherein the first component comprises 1-30% by weight of the total amount of the liquid crystal composition; the second component comprises 20-80% by weight of the total amount of the liquid crystal composition; and the third component comprises 5-50% by weight of the total amount of the liquid crystal composition.

5. The liquid crystal composition according to claim 1, wherein the compound of formula I-1 is selected from a group consisting of the following compounds: 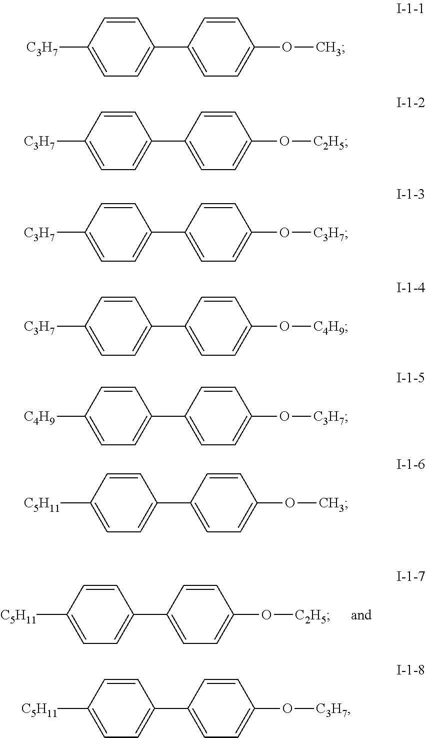
and
the compound of formula I-2 is selected from a group consisting of the following compounds:

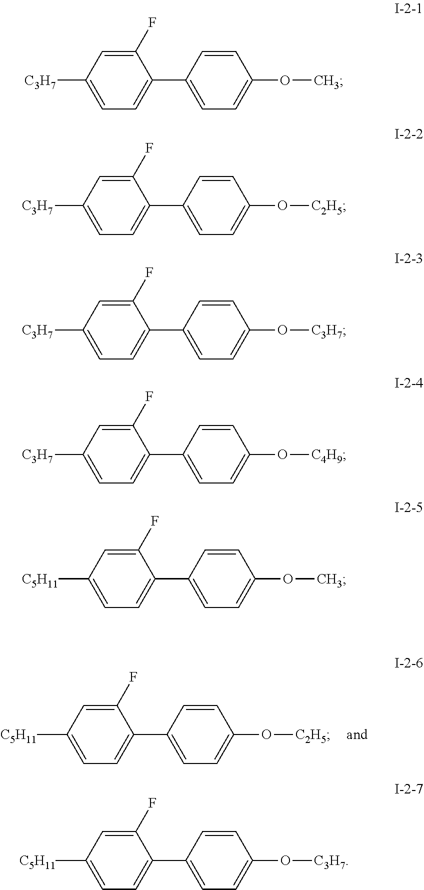

6. The liquid crystal composition according to claim 1, wherein the first component consists of one or more compounds of formula I-1 and one or more compounds of formula I-2, wherein the one or more compounds of formula I-1 comprise 0-15% by weight of the total amount of the liquid crystal composition, the one or more compounds of formula I-2 comprise 0.5-15% by weight of the total amount of the liquid crystal composition, and the content of any one of the one or more compounds of formula I-1 and the one or more compounds of formula I-2 is no more than 10% by weight of the total amount of the liquid crystal composition.

7. The liquid crystal composition according to claim 6, wherein the one or more compounds of formula I-1 comprise 0.5-15% by weight of the total amount of the liquid crystal composition; the one or more compounds of formula I-2 comprise 0.5-15% by weight of the total amount of the liquid crystal composition.

8. The liquid crystal composition according to claim 1, wherein the liquid crystal composition further comprises:
a fourth component comprising one or more compounds of formula IV: 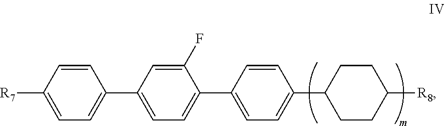
in which,
R₇ and R₈ are same or different, and each independently represents H, F, C₁-C₅ linear or branched alkyl or alkoxy, or C₂-C₅ alkenyl;
m represents 0 or 1, and when m=0, R₈ represents H or F.

9. The liquid crystal composition according to claim 8, wherein the first component comprises 5-20% by weight of the total amount of the liquid crystal composition; the second component comprises 40-70% by weight of the total amount of the liquid crystal composition; the third component comprises 10-35% by weight of the total amount of the liquid crystal composition; and the fourth component comprises 0-10% by weight of the total amount of the liquid crystal composition.

10. The liquid crystal composition according to claim 8, wherein the fourth component comprises one or more compounds selected from a group consisting of the following compounds: 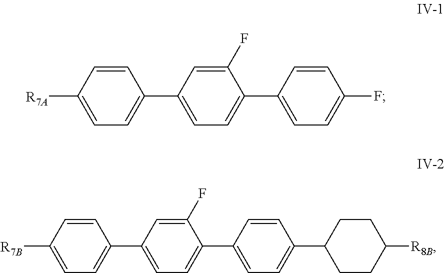
in which,
R_{7A}, R_{7B} and R_{8B} are same or different, and each independently represents C₁-C₅ alkyl or alkoxy.

11. The liquid crystal composition according to claim 9, wherein the first component comprises 5-12% by weight of the total amount of the liquid crystal composition; the second component comprises 49-67% by weight of the total amount of the liquid crystal composition; the third component comprises 12-33% by weight of the total amount of the liquid crystal composition; and the fourth component comprises 2-8% by weight of the total amount of the liquid crystal composition.

12. The liquid crystal composition according to claim 10, wherein the liquid crystal composition comprises:
4% by weight of the total amount of the liquid crystal composition of compound 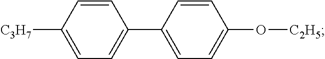
4% by weight of the total amount of the liquid crystal composition of compound 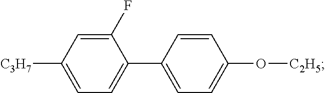
7% by weight of the total amount of the liquid crystal composition of compound 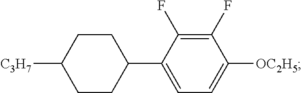
8% by weight of the total amount of the liquid crystal composition of compound 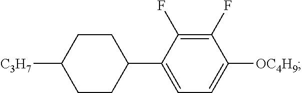
6% by weight of the total amount of the liquid crystal composition of compound 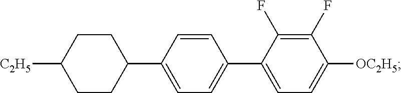 [SMILES: CCOc1ccc(-c2ccc(C3CCC(CC)CC3)cc2)c(F)c1F]
7% by weight of the total amount of the liquid crystal composition of compound 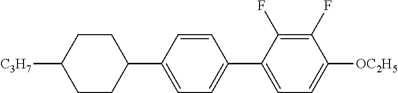
7% by weight of the total amount of the liquid crystal composition of compound 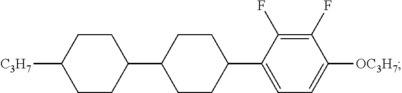
7% by weight of the total amount of the liquid crystal composition of compound 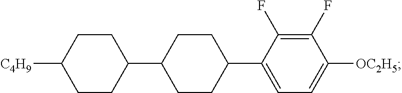
7% by weight of the total amount of the liquid crystal composition of compound 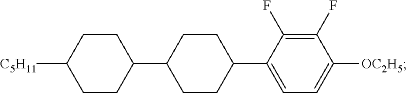
22% by weight of the total amount of the liquid crystal composition of compound 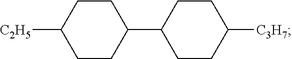
11% by weight of the total amount of the liquid crystal composition of compound 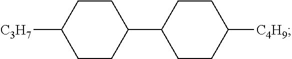
4% by weight of the total amount of the liquid crystal composition of compound 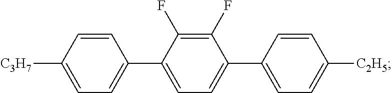
4% by weight of the total amount of the liquid crystal composition of compound 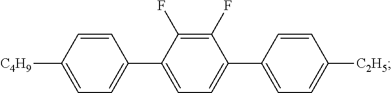
and
2% by weight of the total amount of the liquid crystal composition of compound 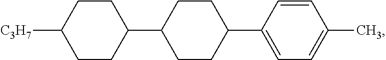
or the liquid crystal composition comprises:
4% by weight of the total amount of the liquid crystal composition of compound 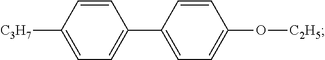
8% by weight of the total amount of the liquid crystal composition of compound 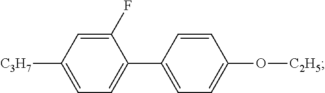
7% by weight of the total amount of the liquid crystal composition of compound 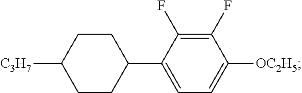
8% by weight of the total amount of the liquid crystal composition of compound 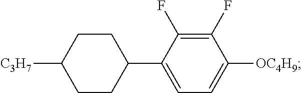
6% by weight of the total amount of the liquid crystal composition of compound 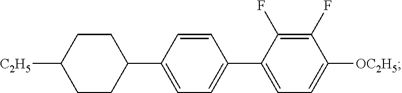 [SMILES: CCOc1ccc(-c2ccc(C3CCC(CC)CC3)cc2)c(F)c1F]
7% by weight of the total amount of the liquid crystal composition of compound 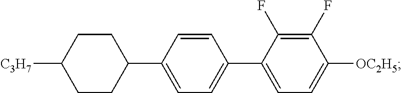
7% by weight of the total amount of the liquid crystal composition of compound 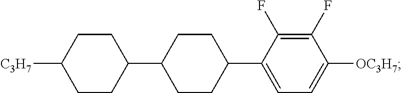
7% by weight of the total amount of the liquid crystal composition of compound 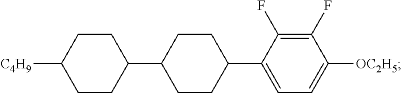
7% by weight of the total amount of the liquid crystal composition of compound 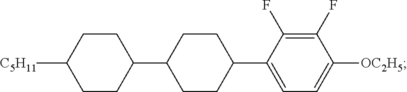
22% by weight of the total amount of the liquid crystal composition of compound 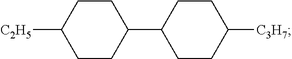
11% by weight of the total amount of the liquid crystal composition of compound 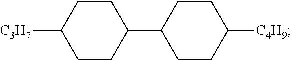
2% by weight of the total amount of the liquid crystal composition of compound 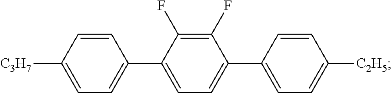
2% by weight of the total amount of the liquid crystal composition of compound 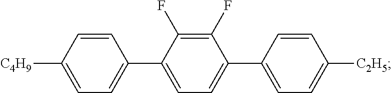
and
2% by weight of the total amount of the liquid crystal composition of compound 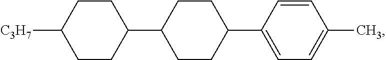
or the liquid crystal composition comprises:
9% by weight of the total amount of the liquid crystal composition of compound 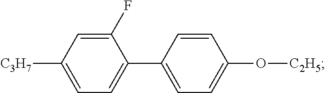
17% by weight of the total amount of the liquid crystal composition of compound 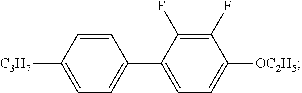
17% by weight of the total amount of the liquid crystal composition of compound 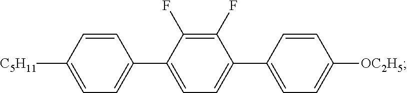
12% by weight of the total amount of the liquid crystal composition of compound 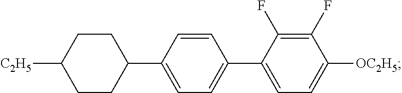 [SMILES: CCOc1ccc(-c2ccc(C3CCC(CC)CC3)cc2)c(F)c1F]
13% by weight of the total amount of the liquid crystal composition of compound 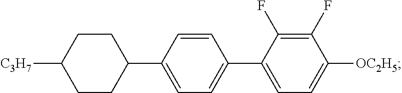
12% by weight of the total amount of the liquid crystal composition of compound 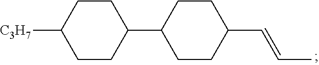
10% by weight of the total amount of the liquid crystal composition of compound 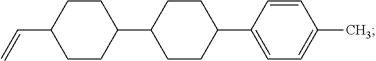 [SMILES: C=CC1CCC(C2CCC(c3ccc(C)cc3)CC2)CC1]
and 10% by weight of the total amount of the liquid crystal composition of compound 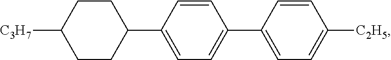
or the liquid crystal composition comprises:
6% by weight of the total amount of the liquid crystal composition of compound 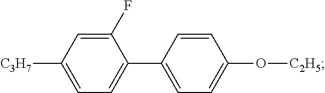
3% by weight of the total amount of the liquid crystal composition of compound 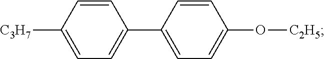
17% by weight of the total amount of the liquid crystal composition of compound 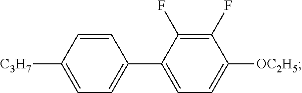
17% by weight of the total amount of the liquid crystal composition of compound 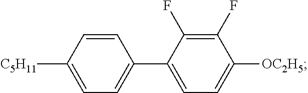
12% by weight of the total amount of the liquid crystal composition of compound 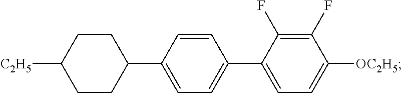 [SMILES: CCOc1ccc(-c2ccc(C3CCC(CC)CC3)cc2)c(F)c1F]
13% by weight of the total amount of the liquid crystal composition of compound 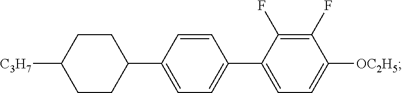
12% by weight of the total amount of the liquid crystal composition of compound 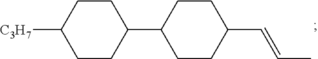
6% by weight of the total amount of the liquid crystal composition of compound 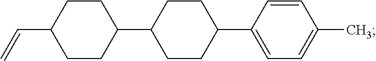 [SMILES: C=CC1CCC(C2CCC(c3ccc(C)cc3)CC2)CC1]
6% by weight of the total amount of the liquid crystal composition of compound 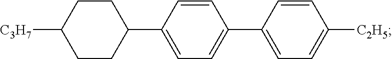
3.5% by weight of the total amount of the liquid crystal composition of compound 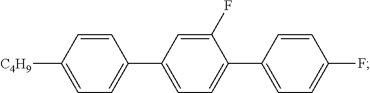
and
4.5% by weight of the total amount of the liquid crystal composition of compound 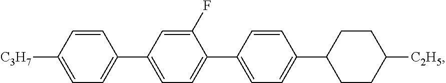
or the liquid crystal composition comprises:
7% by weight of the total amount of the liquid crystal composition of compound 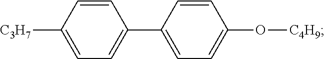
7% by weight of the total amount of the liquid crystal composition of compound 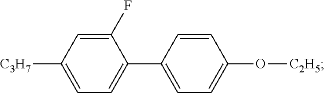
6% by weight of the total amount of the liquid crystal composition of compound 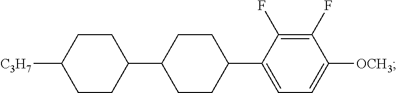
6% by weight of the total amount of the liquid crystal composition of compound 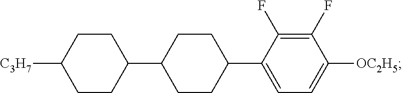
10% by weight of the total amount of the liquid crystal composition of compound 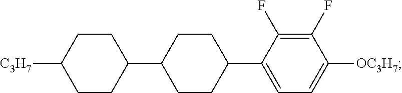
10% by weight of the total amount of the liquid crystal composition of compound 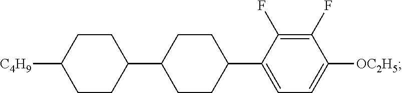
9.5% by weight of the total amount of the liquid crystal composition of compound 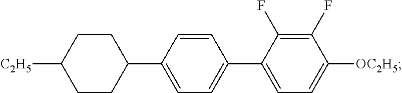 [SMILES: CCOc1ccc(-c2ccc(C3CCC(CC)CC3)cc2)c(F)c1F]
10% by weight of the total amount of the liquid crystal composition of compound 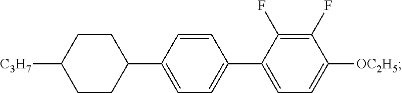
8% by weight of the total amount of the liquid crystal composition of compound 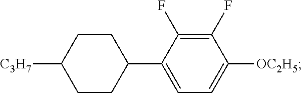
7.5% by weight of the total amount of the liquid crystal composition of compound 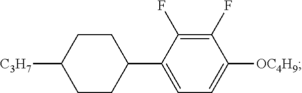
and
19% by weight of the total amount of the liquid crystal composition of compound 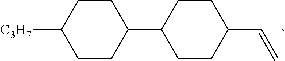
or the liquid crystal composition comprises:
5% by weight of the total amount of the liquid crystal composition of compound 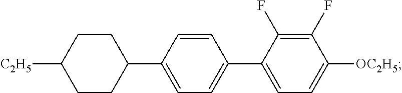 [SMILES: CCOc1ccc(-c2ccc(C3CCC(CC)CC3)cc2)c(F)c1F]
6.5% by weight of the total amount of the liquid crystal composition of compound 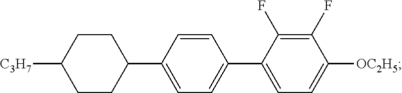
9% by weight of the total amount of the liquid crystal composition of compound 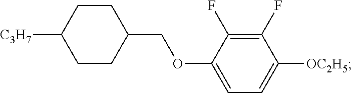
5.5% by weight of the total amount of the liquid crystal composition of compound 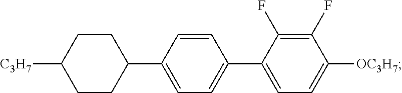
8.5% by weight of the total amount of the liquid crystal composition of compound 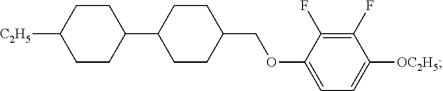 [SMILES: CCOc1ccc(OCC2CCC(C3CCC(CC)CC3)CC2)c(F)c1F]
4% by weight of the total amount of the liquid crystal composition of compound 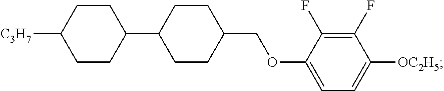
10% by weight of the total amount of the liquid crystal composition of compound 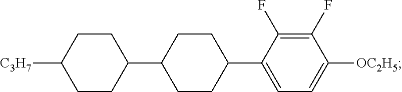
9% by weight of the total amount of the liquid crystal composition of compound 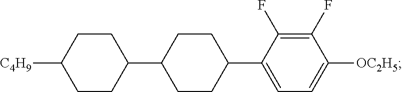
8.5% by weight of the total amount of the liquid crystal composition of compound 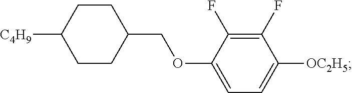
8.5% by weight of the total amount of the liquid crystal composition of compound 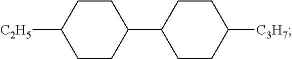
8.5% by weight of the total amount of the liquid crystal composition of compound 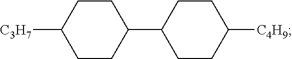
7.5% by weight of the total amount of the liquid crystal composition of compound 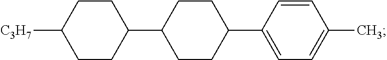
3.5% by weight of the total amount of the liquid crystal composition of compound 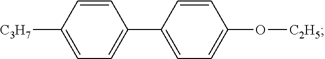
and
6% by weight of the total amount of the liquid crystal composition of compound 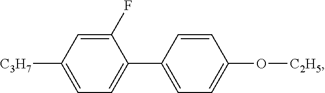
or the liquid crystal composition comprises:
5% by weight of the total amount of the liquid crystal composition of compound 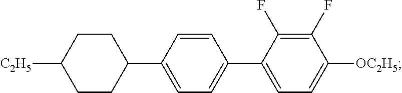 [SMILES: CCOc1ccc(-c2ccc(C3CCC(CC)CC3)cc2)c(F)c1F]
6.5% by weight of the total amount of the liquid crystal composition of compound 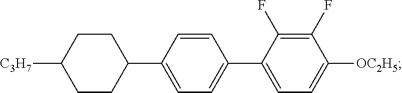
9% by weight of the total amount of the liquid crystal composition of compound 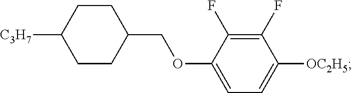
5.5% by weight of the total amount of the liquid crystal composition of compound 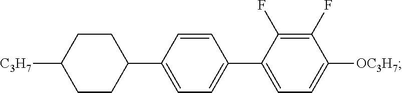
8.5% by weight of the total amount of the liquid crystal composition of compound 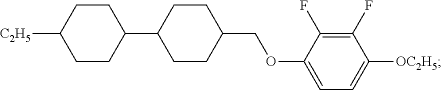 [SMILES: CCOc1ccc(OCC2CCC(C3CCC(CC)CC3)CC2)c(F)c1F]
4% by weight of the total amount of the liquid crystal composition of compound 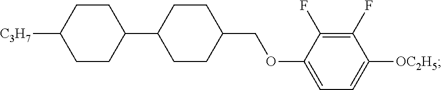
10% by weight of the total amount of the liquid crystal composition of compound 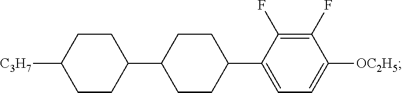
9% by weight of the total amount of the liquid crystal composition of compound 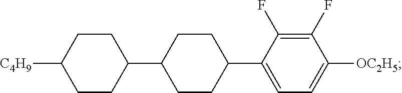
8.5% by weight of the total amount of the liquid crystal composition of compound 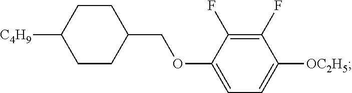
8.5% by weight of the total amount of the liquid crystal composition of compound 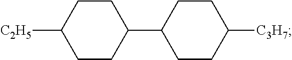
8.5% by weight of the total amount of the liquid crystal composition of compound 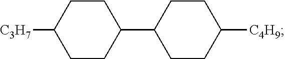
7.5% by weight of the total amount of the liquid crystal composition of compound 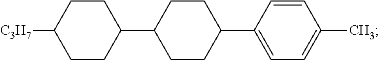
and
9.5% by weight of the total amount of the liquid crystal composition of compound 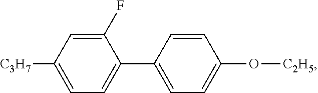
or the liquid crystal composition comprises:
5% by weight of the total amount of the liquid crystal composition of compound 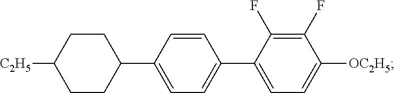 [SMILES: CCOc1ccc(-c2ccc(C3CCC(CC)CC3)cc2)c(F)c1F]
6.5% by weight of the total amount of the liquid crystal composition of compound 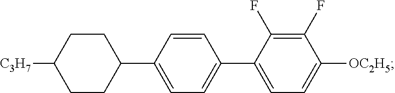
9% by weight of the total amount of the liquid crystal composition of compound 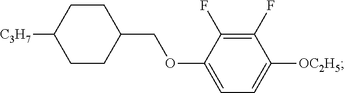
5.5% by weight of the total amount of the liquid crystal composition of compound 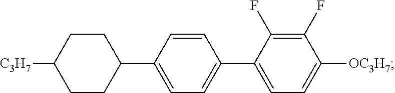
8.5% by weight of the total amount of the liquid crystal composition of compound 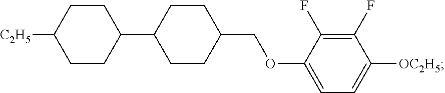 [SMILES: CCOc1ccc(OCC2CCC(C3CCC(CC)CC3)CC2)c(F)c1F]
4% by weight of the total amount of the liquid crystal composition of compound 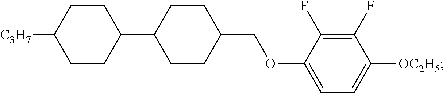
10% by weight of the total amount of the liquid crystal composition of compound 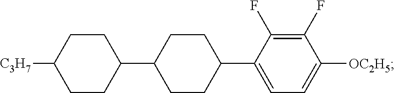
9% by weight of the total amount of the liquid crystal composition of compound 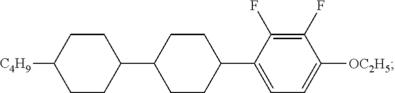
8.5% by weight of the total amount of the liquid crystal composition of compound 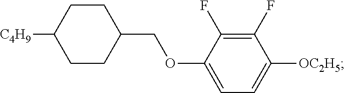
8.5% by weight of the total amount of the liquid crystal composition of compound 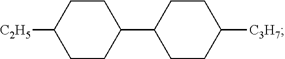
8.5% by weight of the total amount of the liquid crystal composition of compound 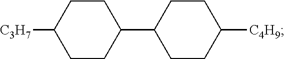
3% by weight of the total amount of the liquid crystal composition of compound 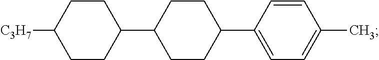
9.5% by weight of the total amount of the liquid crystal composition of compound 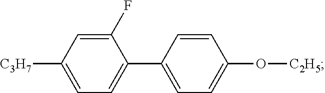
1.5% by weight of the total amount of the liquid crystal composition of compound 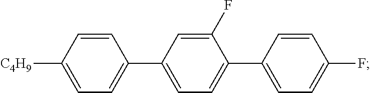
and
3% by weight of the total amount of the liquid crystal composition of compound 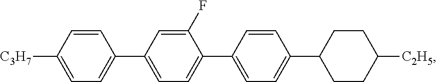
or the liquid crystal composition comprises:
8.5% by weight of the total amount of the liquid crystal composition of compound 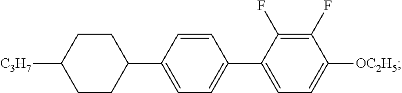
30% by weight of the total amount of the liquid crystal composition of compound 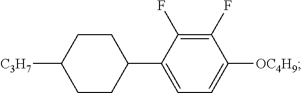
5% by weight of the total amount of the liquid crystal composition of compound 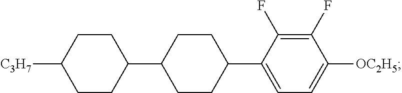
5% by weight of the total amount of the liquid crystal composition of compound 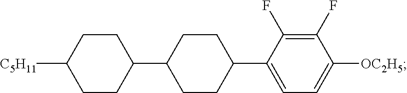
5% by weight of the total amount of the liquid crystal composition of compound 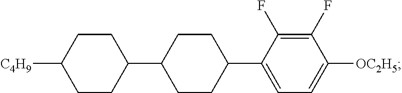
5% by weight of the total amount of the liquid crystal composition of compound 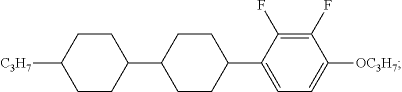
6% by weight of the total amount of the liquid crystal composition of compound 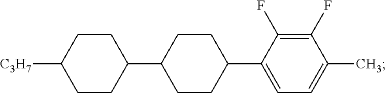
13% by weight of the total amount of the liquid crystal composition of compound 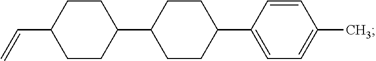 [SMILES: C=CC1CCC(C2CCC(c3ccc(C)cc3)CC2)CC1]
6% by weight of the total amount of the liquid crystal composition of compound 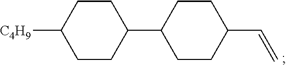
6% by weight of the total amount of the liquid crystal composition of compound 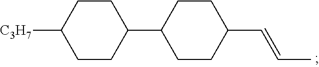
5.5% by weight of the total amount of the liquid crystal composition of compound 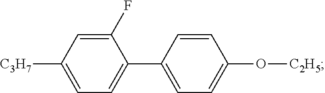
and
5% by weight of the total amount of the liquid crystal composition of compound

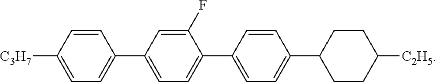

13. A liquid crystal composition having a negative dielectric anisotropy which comprises the liquid crystal composition of claim 1, wherein the liquid crystal composition further comprises one or more additives.

14. A liquid crystal display, wherein the liquid crystal display comprises the liquid crystal composition of claim 1.
